(19) United States
(12) Patent Application Publication
(10) Pub. No.: US 2026/0322868 A1
(43) Pub. Date: Oct. 15, 2026

(54) FILE TRANSMISSION

(71) Applicant: TENCENT TECHNOLOGY (SHENZHEN) COMPANY LIMITED, Shenzhen (CN)

(72) Inventors: Bipeng CHAI, Shenzhen (CN); Manman WANG, Shenzhen (CN); He LIN, Shenzhen (CN); Quan XIA, Shenzhen (CN); Juntao GUO, Shenzhen (CN); Dingpin ZHOU, Shenzhen (CN); Bin LI, Shenzhen (CN); Xucheng TANG, Shenzhen (CN); Dongxuan ZHANG, Shenzhen (CN); Mingrao LI, Shenzhen (CN); Jiamin CHEN, Shenzhen (CN); Junjie LIANG, Shenzhen (CN); Yi ZENG, Shenzhen (CN)

(73) Assignee: TENCENT TECHNOLOGY (SHENZHEN) COMPANY LIMITED, Shenzhen, GD (CN)

(21) Appl. No.: 19/333,158

(22) Filed: Sep. 18, 2025

Related U.S. Application Data
(63) Continuation of application No. PCT/CN2024/104193, filed on Jul. 8, 2024.

(30) Foreign Application Priority Data
Sep. 1, 2023 (CN) 202311131821.4

(51) Int. Cl. H04L 67/06

(52) U.S. Cl. CPC H04L 67/06

(57) ABSTRACT

A receiving terminal device displays a file receiving page with a receiving control for a target file on the file receiving page. In response to a trigger operation on the receiving control, and during a process of an uploading of the target file by a transmitting terminal device, a downloading of content of the target file is started when the target file is being uploaded by the transmitting terminal device. A file download page of the target file with file transmitting state information on the file download page is displayed, the file transmitting state information indicates that the transmitting terminal device is uploading the target file. When the transmitting terminal device completes the uploading of the target file, download progress information indicating that partial content of the target file has been downloaded is displayed on the file download page. Apparatus and non-transitory computer-readable storage medium counterpart embodiments are also contemplated.

### RELATED APPLICATIONS

The present application is a continuation of International Application No. PCT/CN2024/104193, filed on Jul. 8, 2024, which claims priority to Chinese Patent Application No. 202311131821.4, filed on Sep. 1, 2023. The entire disclosures of the prior applications are hereby incorporated by reference.

### FIELD OF THE TECHNOLOGY

This disclosure relates to the field of data transmission technologies, including a file transmission method and apparatus, an electronic device, a storage medium, and a program product.

### BACKGROUND OF THE DISCLOSURE

With the development of data transmission technologies, a transmitting terminal and a receiving terminal can implement a plurality of transmission services through the data transmission technologies, for example, a text message transmission service and a file transmission service.

For the file transmission service, currently, a generally used method is: The transmitting terminal uploads a file to a server through a communication application, and after uploading of the file is completed, the receiving terminal then downloads the file from the server. In this manner, the file cannot be quickly transmitted from the transmitting terminal to the receiving terminal.

In conclusion, currently, there is a problem of relatively low file transmission efficiency between the transmitting terminal and the receiving terminal.

### SUMMARY

Embodiments of this disclosure provide a file transmission method and apparatus, an electronic device, a storage medium, and a program product.

Some aspects of the disclosure provide a file transmission method for a receiving terminal device. In some examples, the receiving terminal device displays a file receiving page with a receiving control for a target file on the file receiving page. In response to a trigger operation on the receiving control, and during a process of an uploading of the target file by a transmitting terminal device, a downloading of content of the target file is started when the target file is being uploaded by the transmitting terminal device. A file download page of the target file with file transmitting state information on the file download page is displayed, the file transmitting state information indicates that the transmitting terminal device is uploading the target file. When the transmitting terminal device completes the uploading of the target file, download progress information indicating that partial content of the target file has been downloaded is displayed on the file download page.

Some aspects of the disclosure provide an apparatus that includes processing circuitry configured to perform the file transmission method.

Some aspects of the disclosure also provide a non-transitory computer-readable storage medium storing instructions which when executed by at least one processor cause the at least one processor to perform the file transmission method.

Some aspects of the disclosure provide a file transmission method for a transmitting terminal device. For example, the transmitting terminal device displays a file transmitting page with an identifier of a target file and a transmitting control for the target file on the file transmitting page. The target file is uploaded, in response to a trigger operation on the transmitting control, to enable a receiving terminal device to start, during a process that the transmitting terminal device is uploading the target file, to download content of the target file that is being uploaded by the transmitting terminal device. A file transmission page of the target file is displayed, the file transmission page includes a transmitting progress identifier indicating an uploading process of the target file.

Some aspects of the disclosure provide an apparatus that includes processing circuitry configured to perform the file transmission method.

Some aspects of the disclosure also provide a non-transitory computer-readable storage medium storing instructions which when executed by at least one processor cause the at least one processor to perform the file transmission method.

Some aspects of the disclosure provide a file transmission method for a server device. For example, a target server device receives at least a current file block of a target file and association file upload information of the current file block that are uploaded by a transmitting terminal device. A preset file set is updated based on the current file block and the association file upload information of the current file block, to obtain an updated file set. Target file download information that is transmitted by a receiving terminal device is received. From the updated file set, a file block, and association file download information of the file block are determined according to the target file download information. The file block and the association file download information of the file block are transmitted to the receiving terminal device, to enable the receiving terminal device to obtain the target file when the transmitting terminal device is uploading the target file.

Some aspects of the disclosure provide an apparatus that includes processing circuitry configured to perform the file transmission method.

Some aspects of the disclosure also provide a non-transitory computer-readable storage medium storing instructions which when executed by at least one processor cause the at least one processor to perform the file transmission method.

An aspect of the disclosure provides a file transmission method, applied to a receiving terminal, the method includes: displaying a file receiving page, and displaying a receiving control for a target file on the file receiving page, the target file being a file transmitted by a transmitting terminal to the receiving terminal; in response to a trigger operation for the receiving control, in a process in which the transmitting terminal transmits the target file, starting to download content of the target file that has been transmitted by the transmitting terminal, displaying a file download page of the target file, and displaying file transmitting state information on the file download page, the file transmitting state information indicating that the transmitting terminal is transmitting the target file; and displaying, on the file download page when the transmitting terminal completes transmitting of the target file, download progress information indicating that partial content of the target file has been downloaded.

In some aspects, embodiments of this disclosure provide a file transmission apparatus, including: a first display unit, configured to display a file receiving page, and display a receiving control for a target file on the file receiving page, the target file being a file transmitted by a transmitting terminal to a receiving terminal; a download unit, configured to: in response to a trigger operation for the receiving control, in a process in which the transmitting terminal transmits the target file, start to download content of the target file that has been transmitted by the transmitting terminal; a second display unit, configured to display, in response to the trigger operation for the receiving control, a file download page of the target file, and display file transmitting state information on the file download page, the file transmitting state information indicating that the transmitting terminal is transmitting the target file; and a third display unit, configured to display, on the file download page when the transmitting terminal completes transmitting of the target file, download progress information indicating that partial content of the target file has been downloaded.

This disclosure further provides another file transmission method, applied to a transmitting terminal, the method includes: displaying a file transmitting page, and displaying an identifier of a target file and a transmitting control for the target file on the file transmitting page; transmitting the target file to a receiving terminal in response to a trigger operation for the transmitting control, to enable the receiving terminal to start, in a process in which the transmitting terminal transmits the target file, to download content of the target file that has been transmitted by the transmitting terminal; and displaying a file transmission page of the target file, the file transmission page including a transmitting progress identifier of the target file.

Correspondingly, this disclosure provides another file transmission apparatus, including: a fourth display unit, configured to display a file transmitting page, and display an identifier of a target file and a transmitting control for the target file on the file transmitting page; a transmitting unit, configured to transmit the target file to a receiving terminal in response to a trigger operation for the transmitting control, to enable the receiving terminal to start, in a process in which a transmitting terminal transmits the target file, to download content of the target file that has been transmitted by the transmitting terminal; and a fifth display unit, configured to display a file transmission page of the target file, the file transmission page including a transmitting progress identifier of the target file.

This disclosure further provides another file transmission method, applied to a target server, the method including: receiving at least one current file block of a target file transmitted by a transmitting terminal and association file upload information of the current file block; updating a preset file set based on the current file block and the association file upload information, to obtain an updated file set; determining, from the preset file set when receiving target file download information transmitted by a receiving terminal, a file block corresponding to the target file download information and association file download information corresponding to the file block; and returning the file block and the association file download information to the receiving terminal, to enable the receiving terminal to obtain the target file when the transmitting terminal transmits the target file.

Correspondingly, this disclosure provides another file transmission apparatus, including: a receiving unit, configured to receive at least one current file block of a target file transmitted by a transmitting terminal and association file upload information of the current file block; an update unit, configured to update a preset file set based on the current file block and the association file upload information, to obtain an updated file set; a screening unit, configured to determine, from the preset file set when receiving target file download information transmitted by a receiving terminal, a file block corresponding to the target file download information and association file download information corresponding to the file block; and a return unit, configured to return the file block and the association file download information to the receiving terminal, to enable the receiving terminal to obtain the target file when the transmitting terminal transmits the target file.

In addition, an embodiment of the present disclosure further provides an electronic device, including a processor (an example of processing circuitry) and a memory, the memory having an application stored, and the processor being configured to run the application in the memory, to implement the file transmission method provided in this embodiment of the present disclosure.

In addition, an embodiment of this disclosure further provides a computer-readable storage medium (e.g., non-transitory computer-readable storage medium), the computer-readable storage medium having a computer program stored, and the computer program being suitable for being loaded by a processor, to perform any file transmission method provided in this embodiment of this disclosure.

In addition, an embodiment of this disclosure further provides a computer program product, including a computer program, and the computer program, when executed by a processor, implementing any file transmission method provided in this embodiment of this disclosure.

Details of one or more embodiments of this disclosure are provided in the following accompanying drawings and descriptions. Other features, objectives, and advantages of this disclosure become apparent from the specification, the accompanying drawings, and the claims.

### BRIEF DESCRIPTION OF THE DRAWINGS

FIG. 1 is a schematic diagram of a scenario of a file transmission method according to an embodiment of this disclosure;

FIG. 2 is a schematic flowchart 1 of a file transmission method according to an embodiment of this disclosure;

FIG. 3 is a schematic diagram 1 of a file message display page according to an embodiment of this disclosure;

FIG. 4 is a schematic diagram of a file receiving page according to an embodiment of this disclosure;

FIG. 5 is a schematic diagram of a file receiving termination page according to an embodiment of this disclosure;

FIG. 6 is a schematic diagram 2 of a file message display page according to an embodiment of this disclosure;

FIG. 7 is a schematic diagram 1 of a file download page according to an embodiment of this disclosure;

FIG. 8 is a schematic diagram 3 of a file message display page according to an embodiment of this disclosure;

FIG. 9 is a schematic diagram 2 of a file download page according to an embodiment of this disclosure;

FIG. 10 is a schematic diagram 4 of a file message display page according to an embodiment of this disclosure;

FIG. 11 is a schematic diagram of a file receiving suspension page according to an embodiment of this disclosure;

FIG. 12 is a schematic diagram 5 of a file message display page according to an embodiment of this disclosure;

FIG. 13 is a schematic diagram 6 of a file message display page according to an embodiment of this disclosure;

FIG. 14 is a schematic diagram of a file expiration page according to an embodiment of this disclosure;

FIG. 15 is a schematic diagram of an expiration prompt page according to an embodiment of this disclosure;

FIG. 16 is a schematic flowchart 2 of a file transmission method according to an embodiment of this disclosure;

FIG. 17 is a schematic flowchart 3 of a file transmission method according to an embodiment of this disclosure;

FIG. 18 is a schematic diagram 1 of a file transmission page according to an embodiment of this disclosure;

FIG. 19 is a schematic diagram 2 of a file transmission page according to an embodiment of this disclosure;

FIG. 20 is a schematic diagram of a retransmitting page according to an embodiment of this disclosure;

FIG. 21 is a schematic diagram 3 of a file transmission page according to an embodiment of this disclosure;

FIG. 22 is a schematic diagram 4 of a file transmission page according to an embodiment of this disclosure;

FIG. 23 is a schematic diagram 5 of a file transmission page according to an embodiment of this disclosure;

FIG. 24 is a schematic diagram 6 of a file transmission page according to an embodiment of this disclosure;

FIG. 25 is a schematic diagram of a candidate retransmitting page according to an embodiment of this disclosure;

FIG. 26 is a schematic flowchart 4 of a file transmission method according to an embodiment of this disclosure;

FIG. 27 is a schematic flowchart 5 of a file transmission method according to an embodiment of this disclosure;

FIG. 28 is a schematic diagram of a file transmission method according to an embodiment of this disclosure;

FIG. 29 is a schematic diagram of a time sequence of a file transmission method according to an embodiment of this disclosure;

FIG. 30 is a schematic diagram of a transmitting procedure of a target file according to an embodiment of this disclosure;

FIG. 31 is a comparison diagram between an effect of this disclosure and an effect of the related art;

FIG. 32 is a schematic diagram 1 of a structure of a file transmission apparatus according to an embodiment of this disclosure;

FIG. 33 is a schematic diagram 2 of a structure of a file transmission apparatus according to an embodiment of this disclosure;

FIG. 34 is a schematic diagram 3 of a structure of a file transmission apparatus according to an embodiment of this disclosure; and

FIG. 35 is a schematic diagram of a structure of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

The embodiments of this disclosure provide a file transmission method and apparatus, an electronic device, a computer-readable storage medium, and a computer program product. The file transmission apparatus may be integrated in an electronic device, and the electronic device may be a server or a device such as a terminal.

The server may be an independent physical server, or a server cluster or distributed system composed of a plurality of physical servers, or may be a cloud server for providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart watch, a vehicle-mounted terminal, or the like, but is not limited thereto. The terminal and the server may be directly or indirectly connected in a wired or wireless communication manner. This is not limited in this disclosure.

For example, referring to FIG. 1, an example in which a file transmission apparatus is integrated in an electronic device, and the electronic device is a receiving terminal is used. The receiving terminal displays a file receiving page, and displays a receiving control for a target file on the file receiving page, the target file being a file transmitted by a transmitting terminal to the receiving terminal; in response to a trigger operation for the receiving control, in a process in which the transmitting terminal transmits the target file, starts to download content of the target file that has been transmitted by the transmitting terminal, displays a file download page of the target file, and displays file transmitting state information on the file download page, the file transmitting state information indicating that the transmitting terminal is transmitting the target file; and displays, on the file download page when the transmitting terminal completes transmitting of the target file, download progress information indicating that partial content of the target file has been downloaded.

The file transmission method provided in the embodiments of this disclosure relates to a data transmission technology. The file transmission method can enable, in response to the trigger operation for the receiving control of the target file on the file receiving page, the receiving terminal to download the target file transmitted by the transmitting terminal, so that the receiving terminal may display the file transmitting state information on the file download page of the target file. In this way, when the transmitting terminal completes transmitting of the target file, the receiving terminal completes downloading of the partial content of the target file, so that the receiving terminal may display the download progress information indicating that the partial content of the target file has been downloaded. That is, according to the file transmission method, in the process in which the transmitting terminal transmits the target file, the receiving terminal can receive the target file in real time. In this way, file transmission efficiency between the transmitting terminal and the receiving terminal can be improved, and file transmission experience and enthusiasm of a user can be improved.

In a specific implementation of this disclosure, related data such as the target file, the file block, the file transmitting state information, and the download progress information is involved. When the following embodiments of this disclosure are applied to a specific product or technology, a permission or consent is needed, and collection, use, and processing of the related data need to comply with related laws, regulations, and standards of related countries and regions.

Detailed descriptions are separately provided below. A description order of the following embodiments is not construed as a limitation on a preferred order of the embodiments.

In this embodiment, descriptions are provided from the perspective of the file transmission apparatus. The file transmission apparatus may be integrated in the receiving terminal. For example, the receiving terminal may include a device such as a tablet computer, a notebook computer, a personal computer (PC), a wearable device, a virtual reality device, or another intelligent device that can obtain data.

A file transmission method, applied to a receiving terminal, the method including: displaying a file receiving page, and displaying a receiving control for a target file on the file receiving page, the target file being a file transmitted by a transmitting terminal to the receiving terminal; in response to a trigger operation for the receiving control, in a process in which the transmitting terminal transmits the target file, starting to download content of the target file that has been transmitted by the transmitting terminal, displaying a file download page of the target file, and displaying file transmitting state information on the file download page, the file transmitting state information indicating that the transmitting terminal is transmitting the target file; and displaying, on the file download page when the transmitting terminal completes transmitting of the target file, download progress information indicating that partial content of the target file has been downloaded.

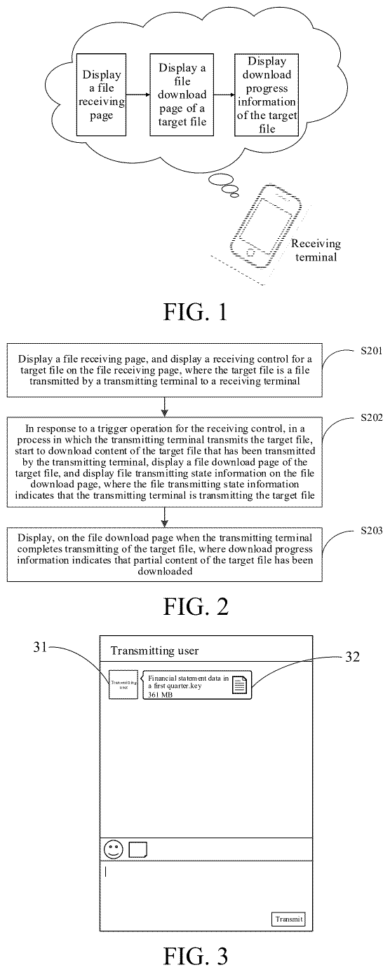

As shown in FIG. 2, a specific procedure of the file transmission method is as shown in operation S201 to operation S203.

S201: Display a file receiving page, and display a receiving control for a target file on the file receiving page, where the target file is a file transmitted by a transmitting terminal to a receiving terminal.

The target file is the file transmitted by the transmitting terminal to the receiving terminal, and the file receiving page includes the receiving control of the target file.

The target file may include at least one type of file or at least one file. In some examples, the target file may include, but is not limited to, at least one file of a text file, an image file, a video file, and an audio file. When the target file is the at least one file of the text file, the image file, the video file, and the audio file, each type of file may include at least one file.

Certainly, the target file may include at least two types of files. For example, the target file may include the text file and the video file. In this case, for example, the text file and the video file may be placed in the same file package such as a compressed package. Based on this, the transmitting terminal transmits the target file to the receiving terminal in a manner of the file package such as the compressed package. In this case, the receiving terminal may download the target file in a form of the file package.

The receiving control may be a control configured to download and receive the target file transmitted by the transmitting terminal. In some examples, there are a plurality of display forms of the receiving control on the file receiving page. For example, the display form of the receiving control may be an icon, text, or a combination of an icon and text.

In operation S201, a manner of “displaying a file receiving page” may be: displaying, when the transmitting terminal starts to transmit the target file, a file message display page corresponding to the target file, and displaying a file display control on the file message display page; and displaying the file receiving page in response to a trigger operation for the file display control.

The file message display page may be a page configured for displaying file-related content of the target file. The file-related content may include, but is not limited to, a file-related message and a file-related control of the target file. The file message display page may be an instant messaging page. For example, a receiving user on the receiving terminal may log in to an instant messaging application, to display the file message display page. The receiving user may refer to an account logged in to the instant messaging application in the receiving terminal.

The file display control may carry information indicating that the transmitting terminal starts to transmit the target file. A display form of the file display control on the file message display page may include an icon and text.

For the operation of “displaying the file receiving page in response to a trigger operation for the file display control”, the receiving terminal may display the file receiving page in response to a tapping operation or a touch operation for the file display control.

S202: In response to a trigger operation for the receiving control, in a process in which the transmitting terminal transmits the target file, start to download content of the target file that has been transmitted by the transmitting terminal, display a file download page of the target file, and display file transmitting state information on the file download page, where the file transmitting state information indicates that the transmitting terminal is transmitting the target file.

The file download page includes the file transmitting state information, that is, the file download page displays the file transmitting state information. The file transmitting state information indicates that the transmitting terminal is transmitting the target file.

For operation S202, in this disclosure, after the file receiving page is displayed, the file download page of the target file may be displayed in response to the trigger operation for the receiving control on the file receiving page.

For operation S201 and operation S202, descriptions are provided herein by using specific examples. For example, when the target file is a text file, a transmitting user in the transmitting terminal may log in to the instant messaging application, the transmitting user may be an account that is logged in to the instant messaging application in the transmitting terminal, and a receiving user in the receiving terminal may also log in to the instant messaging application in the receiving terminal. Then, the transmitting terminal transmits the text file to the receiving user in the receiving terminal through the transmitting user.

When the transmitting terminal starts to transmit the text file, the receiving terminal displays a file message display page of the text file through the instant messaging application. As shown in FIG. 3, the file message display page may be an instant messaging session page between the transmitting user and the receiving user. An object identifier 31 of the transmitting user is displayed on the instant messaging session page, and a display form of the object identifier may be an image. The instant messaging session page may include a file display control 32, and a display form of the file display control includes an icon of the text file and a file name of the text file. As shown in FIG. 3, the file name of the text file may be “financial statement data in a first quarter.key”.

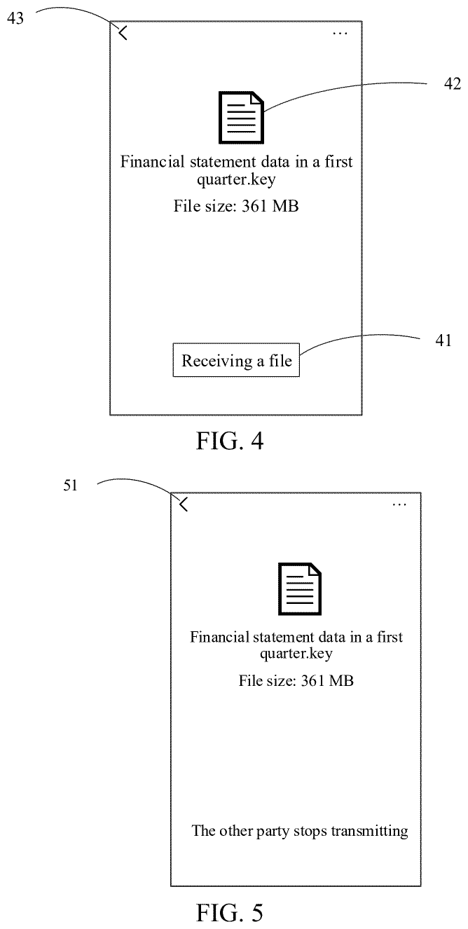

When an object such as a user performs a trigger operation on the file display control, the receiving terminal displays the file receiving page in response to the trigger operation for the file display control. As shown in FIG. 4, the file receiving page includes a receiving control 41 of the text file, a candidate file icon 42 of the text file, and a target return control 43. The file name of the text file is, for example, “financial statement data in a first quarter.key”, and size attribute information of the text file is, for example, “file size: 361 MB”.

Before a trigger operation is not performed on the receiving control 41, the object may perform a tapping operation on the target return control 43, to display the file message display page shown in FIG. 3.

In this embodiment of this disclosure, after the file download page of the target file is displayed, the transmitting terminal may stop transmitting the target file. Correspondingly, the receiving terminal responds to this case. In some examples, when stopping transmitting the target file, the transmitting terminal displays a file receiving termination page, where the file receiving termination page includes a page return control and transmission stopping indication information of the target file; and displays the file message display page in response to a trigger operation for the page return control, and displays a first file state indication identifier on the file message display page, where the first file state indication identifier indicates that transmission of the target file is terminated.

There may be a plurality of reasons why the transmitting terminal stops transmitting the target file, for example, a network interruption, or the object performs an operation on the transmitting terminal, to stop transmitting the target file. The object performs an operation on the transmitting terminal, for example, the transmitting terminal suspends transmitting the target file, or the transmitting terminal scans and kills the instant messaging application.

Further, when the transmitting terminal stops transmitting the target file and a stop time period exceeds a preset time threshold, the file receiving termination page may be displayed.

A display form of the page return control may be an icon or text. The transmission stopping indication information may be information indicating that the transmitting terminal stops transmitting the target file.

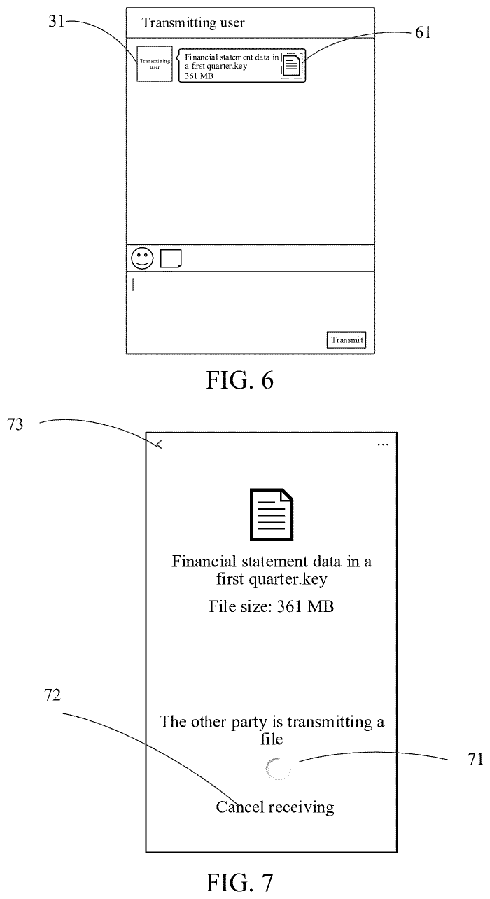

An example in which the target file is the text file is used herein for description. For example, in this disclosure, when the transmitting terminal stops transmitting the text file, the file receiving termination page is displayed. As shown in FIG. 5, the file receiving termination page may include a page return control 51, the name of the text file, for example, “financial statement data in a first quarter.key”, the size attribute information of the text file, for example, “file size: 361 MB”, and transmission stopping indication information of the text file, for example, “the other party stops transmitting”. Then, when the object performs a tapping operation on the page return control, the receiving terminal may display the file message display page in response to the tapping operation on the page return control. Then, as shown in FIG. 6, a first file state indication identifier 61 is displayed on the file message display page. A display form of the first file state indication identifier 61 may be an icon. The first file state indication identifier 61 may be displayed on the file display control 32.

In this embodiment of this disclosure, after the file download page of the target file is displayed, downloading of the target file may be further canceled, and then downloading of the target file may be further continued. For example, the file download page includes a cancel control. Based on this, the receiving terminal may display the file receiving page in response to a trigger operation for the cancel control; and continue to download the target file in response to the trigger operation for the receiving control on the file receiving page.

When the receiving terminal displays the file receiving page in response to the trigger operation for the cancel control. This case indicates that the receiving terminal has canceled downloading of the target file.

An example in which the target file is the text file is used for description. For example, as shown in FIG. 7, the file download page displays file transmitting state information such as “the other party is transmitting a file”, a state icon 71 corresponding to the file transmitting state information, and a cancel control 72. The state icon 71 may be a dynamic icon. A display form of the cancel control on the file download page may be a text identifier such as “cancel downloading”. When the object performs a tapping operation on the cancel control, the receiving terminal cancels downloading of the text file, and displays the file receiving page shown in FIG. 4. Then, when the object performs a tapping operation on the receiving control 41 on the file receiving page, the receiving terminal may continue to download the text file in response to the trigger operation for the receiving control.

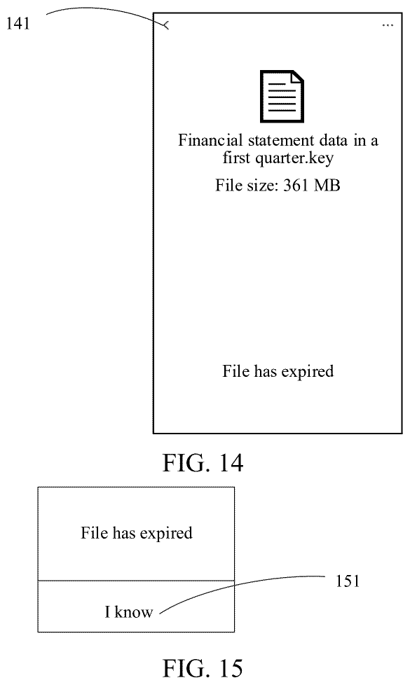

Further, when performing the tapping operation on the receiving control 41 on the file receiving page, the receiving terminal obtains a deadline state of the target file in response to the tapping operation on the receiving control 41. The deadline state may refer to a state indicating whether the target file expires. When the deadline state indicates that the target file does not expire, downloading of the text file is continued; and when the deadline state indicates that the target file has expired, a file expiration page is displayed. As shown in FIG. 14, the file expiration page includes file expiration indication information such as “the file has expired” and a target page return control 141.

Then, when performing a tapping operation on the target page return control 141, the receiving terminal may display a file message display page in response to the tapping operation on the target page return control 141. The file message display page may also include a first file state indication identifier, and the first file state indication identifier indicates that transmission of the target file is terminated. Details are shown in FIG. 6.

The first file state indication identifier may be displayed on the file display control. When a tapping operation is performed on the file display control on the file message display page, an expiration prompt page is displayed. As shown in FIG. 15, the expiration prompt page may include expiration prompt information such as “a file has expired”, and a confirmation control 151 corresponding to the expiration prompt information. When a trigger operation is performed on the confirmation control 151, the receiving terminal may hide the expiration prompt page in response to the trigger operation for the confirmation control, and display the file message display page shown in FIG. 6.

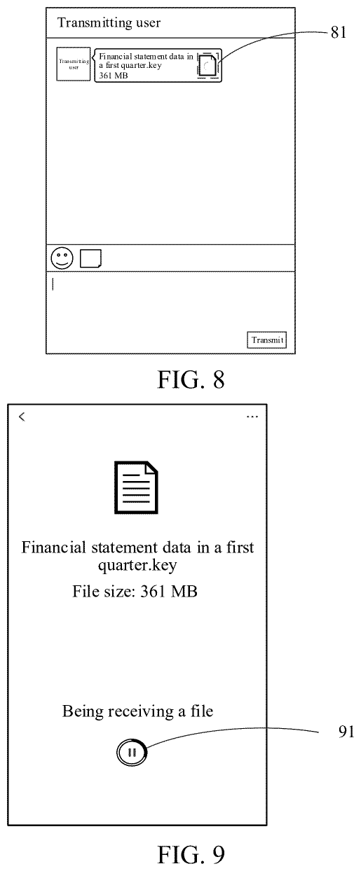

The file download page shown in FIG. 7 may further include a candidate return control 73. Before canceling downloading of the text file, when the object performs a tapping operation on the candidate return control 73, the receiving terminal displays the file message display page. As shown in FIG. 8, a third file state indication identifier 81 is displayed on the file message display page. The third file state indication identifier 81 indicates that the target file is being transmitted. The third file state indication identifier 81 may be displayed on the file display control 32. A display form of the third file state indication identifier 81 may be an icon, and may be a dynamic icon.

In this disclosure, after displaying the file receiving page, the receiving terminal may download the target file. In some examples, a manner in which the receiving end downloads the target file may be shown in operation S2021 to operation S2024.

S2021: Obtain, in response to a trigger operation for a receiving control, initial file download information of a target file in a process in which a transmitting terminal transmits the target file.

For operation S2021, when the object performs the trigger operation on the receiving control, the receiving terminal displays the file download page of the target file on a display interface. In addition, the receiving terminal may obtain the initial file download information of the target file, to download the target file.

The initial file download information may refer to information configured for downloading the target file. In some examples, the initial file download information may include, but is not limited to, at least one of a file block identifier of a file block in the target file, sequence information of the file block, file block download information of the file block in the target file, and reference download information associated with the file block download information.

The file block may refer to file content configured for forming the target file. When the transmitting terminal splits the target file, a candidate file block may be obtained, and then the transmitting terminal may transmit the candidate file block, to enable the receiving terminal to use the candidate file block as the file block and download the file block. The file block download information may include, but is not limited to, at least one of transmission state information of the file block and the sequence information of the file block. The reference download information may refer to information configured for being combined with the file block download information, to download the file block. The reference download information may include, but is not limited to, at least one of reference transmission state information of the file block and reference sequence information of the file block.

For operation S2021, a manner of the operation of “obtaining initial file download information of a target file” may be: obtaining a file identifier of the target file; transmitting, to the target server, a file download request carrying the file identifier, to enable the target server to return the initial file download information based on the file identifier; and receiving the initial file download information of the target file.

A manner of the operation of “obtaining a file identifier of the target file” may be: obtaining a file message of the target file transmitted by the transmitting terminal; and extracting the file identifier of the target file from the file message.

In some examples, a manner of the operation of “obtaining a file message of the target file transmitted by the transmitting terminal” may be: transmitting a message obtaining request to a message server, to enable the message server to return a file message corresponding to the message obtaining request, where the file message is a message transmitted by the transmitting terminal to the message server; and receiving the file message.

For the file message, when receiving the file message, the receiving terminal displays a file display control corresponding to the file message on the displayed file message display page, such as the file display control 32 shown in FIG. 3.

The target server may include a cache server and a storage server. The cache server may be a server that temporarily stores data such as the target file in a preset time period. The cache server may be a server corresponding to a geographical region in which the receiving terminal is located. The storage server may be a server that can permanently store data.

In this disclosure, the target file and related information of the target file may be cached in the cache server, or the target file and related information of the target file may be cached in the storage server. Based on this, a manner of the operation of “transmitting, to the target server, a file download request carrying the file identifier, to enable the target server to return the initial file download information based on the file identifier” may be: transmitting, to the cache server, the file download request carrying the file identifier, to enable the cache server to query initial file download information corresponding to the file identifier; transmitting the file download request carrying the file identifier to the storage server when initial file download information returned by the cache server is not received, to enable the storage server to return the initial file download information based on the file identifier; and receiving the initial file download information returned by the storage server.

The initial file download information and the target file may not exist in the cache server corresponding to the geographical area in which the receiving terminal is located. Based on this, the receiving terminal requests the initial file download information from the storage server.

The cache server may store only interaction data between the receiving terminal and the transmitting terminal in the geographical region in which the cache server is located. The interaction data is, for example, the target file and the related information of the target file, for example, the initial file download information. A receiving terminal and a transmitting terminal that are located in the same geographical region may correspond to the same cache server, a receiving terminal and a transmitting terminal that are located in different geographical regions correspond to different cache servers, and different cache servers may store different interaction data.

When the cache server receives the interaction data between the receiving terminal and the transmitting terminal, the cache server may transmit the interaction data to the storage server, to enable the storage server to store the interaction data. Based on this, when the receiving terminal does not obtain the initial file download information returned by the cache server corresponding to the geographical region in which the receiving terminal is located, the receiving terminal requests the initial file download information from the storage server.

S2022: Request, according to the initial file download information, a file block and association file download information corresponding to the file block from a target server, to enable the target server to return the file block and the association file download information.

The initial file download information includes the file block download information and the reference download information associated with the file block download information. Based on this, in this disclosure, after the initial file download information is obtained, the file block of the target file and the association file download information corresponding to the file block may be requested from the target server. In some examples, a manner of operation S2022 of “requesting, according to the initial file download information, a file block of the target file and association file download information corresponding to the file block from a target server” may be: fusing the file block download information and the reference download information, to obtain fused download information; and requesting, based on the fused download information, the file block of the target file and the association file download information corresponding to the file block from the target server.

A manner of the operation of “fusing the file block download information and the reference download information, to obtain fused download information” may be: determining, in sequence information included in the file block download information, target sequence information that is the same as reference sequence information included in the reference download information; determining, in transmission state information of the file block download information, target transmission state information corresponding to the target sequence information; and fusing the target transmission state information with reference transmission state information in the reference download information, to obtain fused transmission state information, and generating the fused download information based on the fused transmission state information.

The fused transmission state information may be used as the fused download information. Alternatively, the fused transmission state information is used as the fused download information based on the fused state information and the target sequence information.

For example, the transmitting terminal may divide the target file into 256 candidate file blocks, and then upload the candidate file blocks to the target server according to sequence information of each candidate file block in the target file. When the candidate file blocks have been successfully uploaded to the target server, transmission state information corresponding to each candidate file block may be 1. When the file blocks are not successfully uploaded to the target server, transmission state information corresponding to each candidate file block may be 0.

Correspondingly, when the receiving terminal requests a file block from the candidate file blocks, the file block download information may include sequence information and transmission state information of each of the 256 file blocks. The reference download information may include reference sequence information and reference transmission state information of each of a 129^{th} file block to a 256^{th} file block. Based on this, in this disclosure, it may be determined that, in the sequence information of the file block download information, the target sequence information that is the same as the reference sequence information in the reference download information is sequence information of the 129^{th} file block to the 256^{th} file block.

Correspondingly, in the transmission state information of the file block download information, the target transmission state information corresponding to the target sequence information is transmission state information of the 129^{th} file block to the 256^{th} file block. Based on this, candidate transmission state information of the 129^{th} file block to the 256^{th} file block in the reference download information and the transmission state information of the 129^{th} file block to the 256^{th} file block in the file block download information may be added, to obtain the fused download information.

In this disclosure, after the file block download information and the reference download information are fused, to obtain the fused download information, the file block and the association file download information corresponding to the file block may be requested from the target server. In some examples, a manner of “requesting, based on the fused download information, a file block and association file download information corresponding to the file block from a target server” may be: identifying, from the fused download information, a current transmission state of a file block corresponding to the fused download information; and when the current transmission state is an uploaded state, requesting, from the target server, a file block corresponding to the association file download information and the association file download information corresponding to the file block.

The uploaded state may be a state in which the file block is successfully uploaded to the target server.

When the fused transmission state information of the fused download information is 1, it may be determined that, the current transmission state of the file block is the uploaded state; and when the fused transmission state information of the fused download information is 0, it may be determined that, the current transmission state of the file block is a non-uploaded state.

S2023: Receive the association file download information and the file block, and use the association file download information as the initial file download information.

The server may return at least one file block at a time. When the server returns a plurality of file blocks at a time, the receiving terminal may receive the plurality of file blocks in parallel.

S2024: Return to perform the operation of requesting, according to the initial file download information, the file block and the association file download information corresponding to the file block from the target server, until each piece of association file download information is the initial file download information, to obtain a plurality of file blocks corresponding to the target file, and combine the plurality of file blocks to obtain the target file.

In operation S2024, a manner of the operation of “combining the plurality of file blocks to obtain the target file” may be: splicing the file blocks based on the sequence information of the file blocks, to obtain the target file.

S203: Display, on the file download page when the transmitting terminal completes transmitting of the target file, download progress information indicating that partial content of the target file has been downloaded.

The download progress information indicates that the partial content of the target file has been downloaded.

Because when the transmitting terminal transmits the file block, the receiving terminal may receive the file block, based on this, when the transmitting terminal completes transmitting of the target file, the download progress information displayed on the file download page indicates that the partial content of the target file has been downloaded.

In some examples, an example in which the target file is the text file is used herein for description. When the transmitting terminal completes transmitting of the text file, the receiving terminal has downloaded the partial content of the target file. As shown in FIG. 9, the download progress information may include a progress bar 91 and progress indication information, for example, “receiving a file” corresponding to the progress bar. The progress bar may be a circular progress bar.

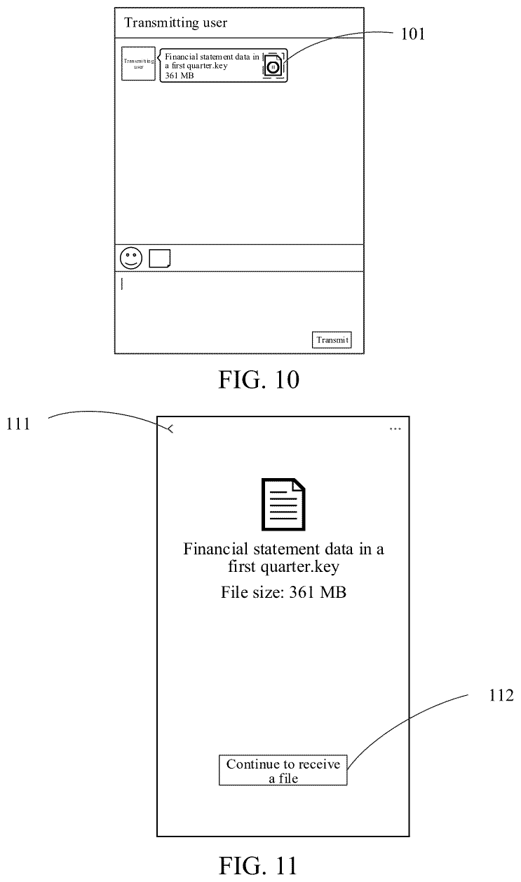

As shown in FIG. 9, the file download page may further include a candidate page return control 92. When the object may perform a tapping operation on the candidate page return control 92, the receiving terminal may display the file message display page in response to the tapping operation for the candidate page return control 92. As shown in FIG. 10, the file message display page may display a fourth file state indication identifier 101, and the fourth file state indication identifier 101 indicates that the receiving terminal is downloading the target file. The fourth file state indication identifier 101 may be displayed on the file display control 32.

In this embodiment of this disclosure, after the file download page displays the download progress information of the target file, when the receiving terminal suspends receiving the target file, downloading of the target file may be further continued. In some examples, when the receiving terminal suspends receiving the target file, the receiving terminal may display a file receiving suspension page. The file receiving suspension page includes a receiving continuation control, and the receiving terminal continues to download the target file in response to a trigger operation for the receiving continuation control.

That the receiving terminal suspends receiving the target file may be caused by a network interruption, or may be triggered by an operation of the object. When the receiving terminal suspending receiving the target file is triggered by the operation of the object, the file download page may further include a suspension control. Based on this, before the operation of “displaying a file receiving suspension page”, the receiving terminal may suspend receiving of the target file in response to a trigger operation for the suspension control, and display the file receiving suspension page.

In this disclosure, after displaying the file receiving suspension page, the receiving terminal may display the file receiving suspension page. The file receiving suspension page may further include a return control other than the receiving continuation control. Based on this, after the operation of “displaying a file receiving suspension page”, the receiving terminal may further return to display the file display page. In some examples, the receiving terminal may display the file message display page in response to a trigger operation for the return control; and display a second file state indication identifier on the file message display page, where the second file state indication identifier indicates that transmission of the target file is suspended.

A display form of the return control on the file receiving suspension page may include an icon and a text identifier.

For the file receiving suspension page, an example in which the target file is the text file is used herein for description. For example, as shown in FIG. 9, the file download page may further include a suspension control, and a progress bar 91 is set on the suspension control. The receiving terminal suspends receiving the text file in response to a trigger operation for the suspension control, and displays the file receiving suspension page. As shown in FIG. 11, the file receiving suspension page may include a return control 111 and a receiving continuation control 112.

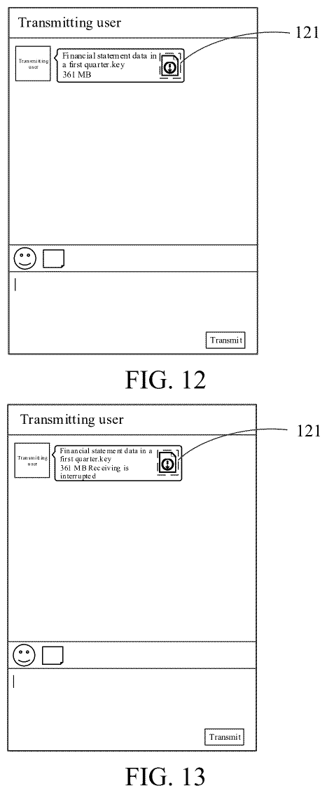

Before the object performs the trigger operation on the receiving continuation control 112, when the object may perform the trigger operation on the return control, the receiving terminal may display the file message display page in response to the trigger operation for the return control 111. As shown in FIG. 12, a second file state indication identifier 121 is displayed on the file message display page. When the object performs the trigger operation on the receiving continuation control, the receiving terminal may continue to download the text file in response to the trigger operation for the receiving continuation control.

When the receiving terminal suspends receiving the target file due to the network interruption, the file receiving suspension page displayed by the receiving terminal may also be shown in FIG. 11. In this case, when a tapping operation is performed on the return control 111 of the file receiving suspension page, the receiving terminal may display the file message display page. As shown in FIG. 13, the file message display page displays the second file state indication identifier and the file receiving state information such as “receiving is interrupted”. The file receiving state information may refer to information about a receiving state of the receiving terminal for the target file.

Further, when the receiving terminal suspends receiving the target file due to the network interruption or the trigger operation performed on the suspension control, the receiving terminal obtains a candidate deadline state of the target file in response to a tapping operation for the receiving continuation control 112 on the file receiving suspension page. The candidate deadline state may refer to a state indicating whether the target file expires; when the candidate deadline state indicates that the target file does not expire, the text file continues to be downloaded; and when the candidate deadline state indicates that the target file has expired, the file expiration page shown in FIG. 14 is displayed.

Then, when performing a tapping operation on the target page return control 141, the receiving terminal may display the message display page shown in FIG. 13 in response to the tapping operation on the target page return control 141. The second file state indication identifier displayed on the file message display page may be displayed on the file display control. When a tapping operation is performed on the file display control, the expiration prompt page shown in FIG. 15 is displayed.

Further, when the transmitting terminal completes transmitting of the target file, and the receiving terminal has completely received the target file, the receiving terminal may display the file message display page. The file message display page may be shown in FIG. 3.

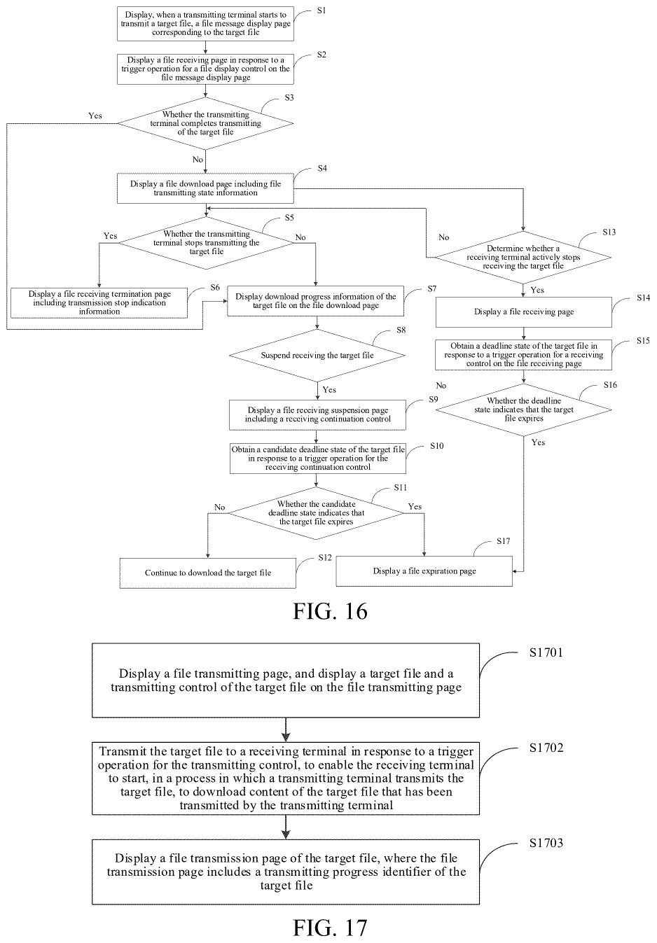

For operation S201 and operation S203, descriptions are further provided herein by using an example in which the target file is the text file, as shown in FIG. 16, and details are shown in operation S1 to operation S17.

S1: Display, when a transmitting terminal starts to transmit a target file, a file message display page corresponding to the target file.

The file message display page displays a file display control.

S2: Display a file receiving page in response to a trigger operation for the file display control on the file message display page.

The file receiving page includes a receiving control of the target file.

S3: Determine, in response to a trigger operation for the receiving control on the file receiving page, whether the transmitting terminal completes transmitting of the target file;
when the transmitting terminal does not complete transmitting of the target file, perform operation S4; and when the transmitting terminal completes transmitting of the target file, perform operation S7.

S4: Display a file download page including file transmitting state information.

The file transmitting state information indicates that the transmitting terminal is transmitting the target file.

S5: Determine whether the transmitting terminal stops transmitting the target file;
when the transmitting terminal stops transmitting the target file and a stop time period exceeds a preset time threshold, perform operation S6; and when the transmitting terminal does not stop transmitting the target file, and the transmitting terminal completes transmitting of the target file, perform operation S7.

S6: Display a file receiving termination page including transmission stopping indication information.

S7: Display download progress information of the target file on the file download page.

The download progress information indicates that partial content of the target file has been downloaded.

S8: Determine whether receiving of the target file is suspended;
when receiving of the target file is suspended, perform operation S9; and when receiving of the target file is not suspended, continue to receive the target file.

S9: Display a file receiving suspension page including a receiving continuation control.

S10: Obtain a candidate deadline state of the target file in response to a trigger operation for the receiving continuation control.

S11: Determine whether the candidate deadline state indicates that the target file has expired;
when the candidate deadline state indicates that the target file does not expire, perform operation S12; and when the candidate deadline state indicates that the target file has expired, perform operation S17.

S12: Continue to download the target file.

S13: Determine whether the receiving terminal actively stops receiving the target file;
when the receiving terminal determines, in response to a trigger operation for a cancel control on the file download page, that the receiving terminal actively stops receiving the target file, perform operation S14; and
when the receiving terminal is in a network interruption state, determine that the receiving terminal passively stops receiving the target file, return to perform operation S5.

S14: Display a file receiving page.

S15: Obtain a deadline state of the target file in response to the trigger operation for the receiving control on the file receiving page.

S16: Determine whether the deadline state indicates that the target file has expired;
when the deadline state indicates that the target file has expired, perform operation S17; and when the deadline state indicates that the target file does not expire, return to perform operation S5.

S17: Display a file expiration page.

In this disclosure, the file receiving page may be displayed, and the receiving control for the target file is displayed on the file receiving page, where the target file is a file transmitted by the transmitting terminal to the receiving terminal; in response to the trigger operation for the receiving control, in a process in which the transmitting terminal transmits the target file, content of the target file that has been transmitted by the transmitting terminal starts to be downloaded, a file download page of the target file is displayed, and file transmitting state information is displayed on the file download page, the file transmitting state information indicating that the transmitting terminal is transmitting the target file; and download progress information indicating that partial content of the target file has been downloaded is displayed on the file download page when the transmitting terminal completes transmitting of the target file. In this disclosure, the receiving terminal can receive the target file in response to the trigger operation for the receiving control of the target file on the file receiving page, to enable the receiving terminal to receive the target file in real time in a process in which the transmitting terminal transmits the target file, to improve file transmission efficiency between the transmitting terminal and the receiving terminal. In this way, the receiving terminal may display the file transmitting state information on the file download page of the target file, to improve file transmission experience of a user. In this way, when the transmitting terminal completes transmitting of the target file, the receiving terminal may complete downloading of the partial content of the target file, to improve the file transmission efficiency between the transmitting terminal and the receiving terminal. In this way, the receiving terminal may display the download progress information indicating that the partial content of the target file has been downloaded, to improve the file transmission experience and enthusiasm of the user.

According to the method described in the foregoing embodiment, the following further provides detailed descriptions by using an example.

In this embodiment, the file transmission apparatus is integrated in the electronic device, and the electronic device is the transmitting terminal.

As shown in FIG. 17, a specific procedure of the file transmission method is as shown in operation S1701 to operation S1703.

S1701: Display a file transmitting page, and display a target file and a transmitting control of the target file on the file transmitting page.

The file transmitting page includes an identifier of the target file and the transmitting control of the target file. The transmitting control may be a control configured to transmit the target file. The identifier of the target file includes, but is not limited to, at least one of a file name or a file icon of the target file.

In operation S1701, a manner of “displaying a file transmitting page” may be: displaying a file transmission page, where the file transmission page includes a file selection control; obtaining a plurality of candidate files in response to a trigger operation for the file selection control; and displaying the file transmitting page in response to a selection operation for the candidate files.

In response to the selection operation for the candidate files, the transmitting terminal determines the target file from the candidate files and displays the file transmitting page.

S1702: Transmit the target file to a receiving terminal in response to a trigger operation for the transmitting control, to enable the receiving terminal to start, in a process in which the transmitting terminal transmits the target file, to download content of the target file that has been transmitted by the transmitting terminal.

For operation S1702, in this disclosure, a case in which the trigger operation for the transmitting control is a time countdown may be set. When the time countdown for the trigger control ends, the transmitting terminal transmits the target file to the receiving terminal in response to the trigger operation for the transmitting control, to enable the receiving terminal to start, in a process in which the transmitting terminal transmits the target file, to download content of the target file that has been transmitted by the transmitting terminal.

Alternatively, for operation S1702, a candidate object such as a user may perform a tapping operation on the transmitting control. Correspondingly, the transmitting terminal may transmit the target file to the receiving terminal in response to the trigger operation for the transmitting control, to enable the receiving terminal to start, in a process in which the transmitting terminal transmits the target file, to download content of the target file that has been transmitted by the transmitting terminal.

In this embodiment of this disclosure, the transmitting terminal may directly transmit the target file to the receiving terminal, or in a process in which the transmitting terminal transmits the target file to a target server, the receiving terminal may download the target file from the target server.

For the case in which the receiving terminal downloads the target file from the target server in a process in which the transmitting terminal transmits the target file to the target server, in operation S1702, a specific manner of the operation of “transmitting the target file to a receiving terminal in response to a trigger operation for the transmitting control” may be shown in operation S17021 to operation S17024.

S17021: Split the target file in response to the trigger operation for the transmitting control, to obtain at least one candidate file block.

In operation S17021, the operation of “splitting the target file, to obtain at least one candidate file block” may be: obtaining a preset splitting parameter; and splitting the target file based on the preset splitting parameter, to obtain the at least one candidate file block.

The preset splitting parameter may refer to a parameter configured for splitting the target file into the at least one candidate file block. The preset splitting parameter may include a size of a to-be-split candidate file block. For example, the preset splitting parameter may be set to 1 MB. In this disclosure, the target file may be split, according to the size of 1 MB, into candidate file blocks whose size is 1 MB.

S17022: Select at least one current file block from the candidate file blocks, and obtain association file upload information corresponding to the current file block.

The current file block is a file block that is not uploaded. In some examples, the current file block is a file block uploaded to the target server.

After the target file is split into the candidate file blocks, the current file block may be determined from the candidate file blocks, to upload the current file block to the target server.

After the target file is split into the candidate files, candidate sequence information corresponding to each candidate file block may be obtained. Based on this, in operation S17022, a manner of the operation of “determining at least one current file block from the candidate file blocks” may be: selecting the at least one current file block from the candidate file blocks based on the candidate sequence information.

For example, the at least one candidate file block may be sequentially used as the current file block according to the candidate sequence information. For example, a 3^{rd} candidate file block and a 4^{th} candidate file block may be used as the current file blocks.

In operation S17022, a manner of the operation of “obtaining association file upload information corresponding to the current file block” may be: obtaining preset file transmission information corresponding to the current file block, and detecting upload state information of an uploaded target file block in the candidate file block; and updating the preset file transmission information based on the upload state information, to obtain the association file upload information corresponding to the current file block.

The preset file transmission information may refer to transmission information corresponding to the preset target file. In some examples, the preset file transmission information may include preset upload state information and candidate sequence information that correspond to each candidate file block of a preset quantity of candidate file blocks.

A manner of the operation of “detecting upload state information of an uploaded target file block in the candidate file block” may be: obtaining a file block upload record; querying the file block upload record for file block sequence information of the uploaded target file block in the candidate file block; and extracting, when the file block sequence information exists, upload state information corresponding to the file block sequence information from the file block upload record, and using the upload state information corresponding to the file block sequence information as the upload state information of the target file block.

A manner of the operation of “updating the preset file transmission information based on the upload state information, to obtain the association file upload information corresponding to the current file block” may be: replacing the preset upload state information in the preset file transmission information with the upload state information, to obtain the association file upload information corresponding to the current file block.

Correspondingly, because the upload state information may replace only some preset upload state information, for example, there are 10 candidate file blocks, and five candidate file blocks whose sequence information ranks the top five are uploaded target file blocks, only the five target file blocks have the upload state information. Correspondingly, only the upload state information of the five target file blocks can replace preset upload state information corresponding to the five target file blocks. Based on this, the association file upload information may include association upload information corresponding to the candidate file block, and the association upload information may include the upload state information and the candidate sequence information, or include the upload state information, preset state information, and the candidate sequence information.

The operation of “obtaining association file upload information corresponding to the current file block” is described herein by using an example. For example, in this disclosure, bit states 0 and 1 may be configured for representing the upload state information and the preset state information. When the target file is not uploaded, the preset upload state information may be set to 0. When the uploaded target file block exists in the candidate file block, preset upload information corresponding to the target file block may be replaced with the upload state information corresponding to the target file block. For example, preset upload information 0 corresponding to the target file block is replaced with upload state information 1 corresponding to the target file block, to update the preset file transmission information, so as to obtain the association file upload information.

S17023: Transmit the current file block and the association file upload information to a target server, to enable the target server to transmit a current file block of the target file to the receiving terminal based on the association file upload information.

After the transmitting terminal transmits the at least one current file block and the association file upload information to the target server, when the target server receives the current file block and the association file upload information, the target server may store the current file block and the association file upload information, to enable the receiving terminal to download the current file block and the association file upload information from the target server.

S17024: Return to perform the operation of selecting the at least one current file block from the candidate file blocks, until each candidate file block is the current file block, to enable the target server to transmit each current file block of the target file to the receiving terminal.

S1703: Display a file transmission page of the target file, where the file transmission page includes a transmitting progress identifier of the target file.

The file transmission page includes the transmitting progress identifier of the target file. The transmitting progress identifier may indicate a progress of transmitting the target file by the transmitting terminal.

The file transmission page may be a candidate instant messaging session page. The candidate instant messaging session page may be an instant messaging session page between a transmitting user in the transmitting terminal and a receiving user in the receiving terminal. The transmitting user and the receiving user may display the instant messaging session page through an instant messaging application.

The file transmission page may further include a transmission state control corresponding to the transmitting progress identifier. In some examples, the transmitting progress identifier may be displayed on the transmission state control.

After the operation of “displaying a file transmission page of the target file”, in this disclosure, transmitting of the target file to the receiving terminal may be further stopped. In some examples, when transmitting the target file, the transmitting terminal stops transmitting the target file to the receiving terminal in response to a trigger operation for the transmission state control control; and replaces the transmitting progress identifier with a stop identifier for stopping transmitting the target file.

An example in which the target file is a text file is used for description. The file transmission page is a candidate instant messaging session page. In some examples, the file transmission page is the instant messaging session page between the transmitting user in the transmitting terminal and the receiving user in the receiving terminal.

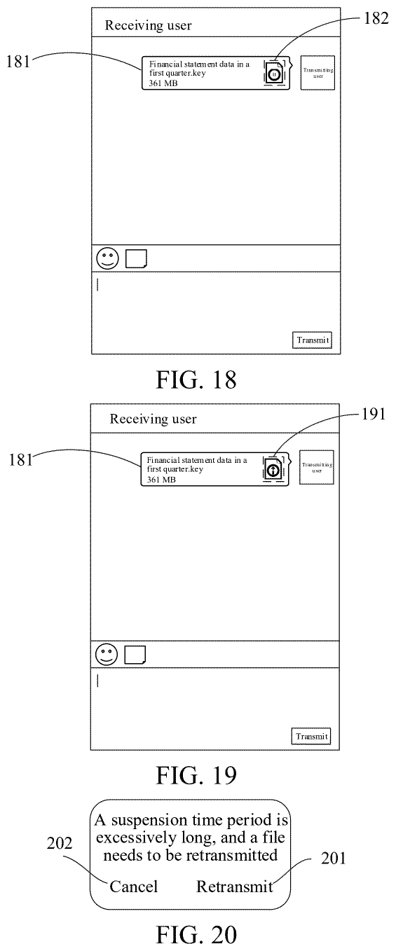

As shown in FIG. 18, when the transmitting terminal transmits the text file, the file transmission page may include a transmission state control 181, a file name such as “financial statement data in a first quarter.key” displayed on the transmission state control 181, and a transmitting progress identifier 182 displayed on the transmission state control 181.

When the object may perform a tapping operation on the transmission state control, the transmitting terminal may stop transmitting the text file to the receiving terminal in response to a stop operation for the transmission state control control. In this case, as shown in FIG. 19, the transmitting progress identifier on the file transmission page is replaced with a stop identifier 191 for stopping transmitting the text file.

In this disclosure, after the target file stops being transmitted to the receiving terminal, the target file may be invalid. In this case, the target file may be further retransmitted. In some examples, when a stop time period in which transmitting of the target file to the receiving terminal stops exceeds a preset time threshold, a retransmitting page is displayed in response to the trigger operation for the transmission state control. The retransmitting page includes a retransmitting control; and the target file is retransmitted to the receiving terminal in response to the trigger operation for the retransmitting control.

When the stop time period in which transmitting of the target file to the receiving terminal stops exceeds the preset time threshold, the target file may be invalid. In this case, if the transmitting terminal needs to transmit the target file, the transmitting terminal needs to retransmit the target file. The transmitting terminal may transmit the target file to the target server, to enable the target server to transmit the target file to the receiving terminal.

A display form of the retransmitting page may be a pop-up window. When the retransmitting page is the pop-up window, the retransmitting page may be displayed on an upper layer of the file transmission page.

An example in which the target file is the text file is used. For example, when the stop time period in which transmitting of the target file to the receiving terminal stops exceeds the preset time threshold, the retransmitting page is displayed in response to the trigger operation for the transmission state control control. As shown in FIG. 20, the retransmitting page includes a retransmitting control 201, a target cancel control 202, and retransmitting indication information such as “a suspension time period is excessively long, and the file needs to be retransmitted”.

When a candidate object performs a tapping operation on the retransmitting control 201, the transmitting terminal retransmits the target file to the receiving terminal in response to the tapping operation for the retransmitting control 201. In this case, as shown in FIG. 24, the receiving terminal hides the retransmitting page, and displays the file transmission page. The stop identifier 191 on the file transmission page is replaced with a termination identifier 211, and a candidate transmission state control control 241 is displayed. The termination identifier 211 may indicate that transmission of the target file is terminated, and the candidate transmission state control 241 displays a file name such as “financial statement data in a first quarter.key” and a candidate transmitting progress identifier 242. The candidate transmitting progress identifier 242 indicates a progress of transmitting the target file by the transmitting terminal. A display form of the candidate transmitting progress identifier 242 may be the same as a display form of the transmitting progress identifier.

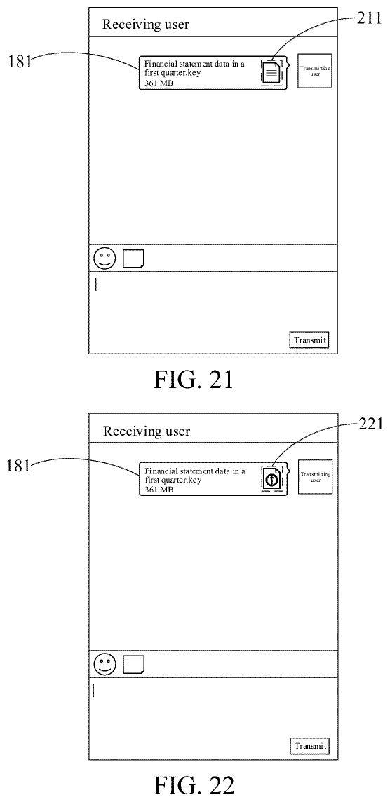

When the candidate object performs a tapping operation on the target cancel control 202, the transmitting terminal hides the retransmitting page and displays the file transmission page in response to the tapping operation for the target cancel control 202. As shown in FIG. 21, the stop identifier 191 on the file transmission page is replaced with the termination identifier 211.

In this disclosure, after the transmitting progress identifier is replaced with the stop identifier for stopping transmitting the target file, the stop identifier may be further replaced with the transmitting progress identifier. In some examples, when stopping transmitting the target file, the transmitting terminal continues to transmit the target file to the receiving terminal in response to the trigger operation for the transmission state control control; and replaces the stop identifier with the transmitting progress identifier.

For example, when the transmitting terminal stops transmitting the target file, an identifier displayed on the transmission state control on the file transmission page is the stop identifier. When the object may perform a tapping operation on the transmission state control, the transmitting terminal may continue to transmit the target file to the receiving terminal in response to a stop operation for the transmission state control. In this case, the stop identifier on the transmission state control is replaced with the transmitting progress identifier.

After “displaying a file transmission page of the target file”, when being disconnected from a network, the transmitting terminal replaces, on the file transmission page, the transmitting progress identifier with a candidate stop identifier, and displays interruption indication information. The candidate stop identifier indicates the transmitting terminal to stop transmitting the target file. The interruption indication information indicates that transmitting of the target file by the transmitting terminal is interrupted.

When the transmitting terminal is disconnected from the network, as shown in FIG. 22, the file transmission page includes the candidate stop identifier 221 and the interruption indication information such as “transmitting is interrupted”. When an interruption time period in which the transmitting terminal interrupts transmitting of the target file exceeds a target preset time threshold, in response to a trigger operation for a transmission state control 181, the candidate retransmitting page shown in FIG. 25 is displayed. The candidate retransmitting page includes a candidate retransmitting control 251, a candidate cancel control 252, and interruption indication information such as “the interruption time period is excessively long, and the file needs to be retransmitted”. In this case, the transmitting terminal hides the candidate retransmitting page, and displays the file transmission page shown in FIG. 24.

When the candidate object performs a tapping operation on the candidate retransmitting control 251 on the candidate retransmitting page, the transmitting terminal retransmits the target file to the receiving terminal in response to the tapping operation for the candidate retransmitting control 251.

When the candidate object performs a tapping operation on the candidate cancel control 252, the transmitting terminal hides a retransmitting page in response to the tapping operation for the candidate cancel control 252, and displays the file transmission page shown in FIG. 21.

After “displaying a file transmission page of the target file”, when the target file stops being transmitted, application state information of the instant messaging application used by the transmitting terminal to transmit the target file is detected, and whether the application state information indicates that the instant messaging application is closed is determined; and when the application state information indicates that the instant messaging application is closed, the instant messaging application is started, and the file transmission page shown in FIG. 22 is displayed. The file transmission page includes the candidate stop identifier 221 and the interruption indication information such as “transmitting is interrupted”.

When the interruption time period in which the transmitting terminal interrupts transmitting of the target file does not exceed the target preset time threshold, the target file continues to be transmitted in response to the trigger operation for the transmission state control 181.

When the interruption time period in which the transmitting terminal interrupts transmitting of the target file exceeds the target preset time threshold, for a processing manner of the transmitting terminal, refer to the foregoing descriptions about FIG. 20 and FIG. 21, and details are not described herein again.

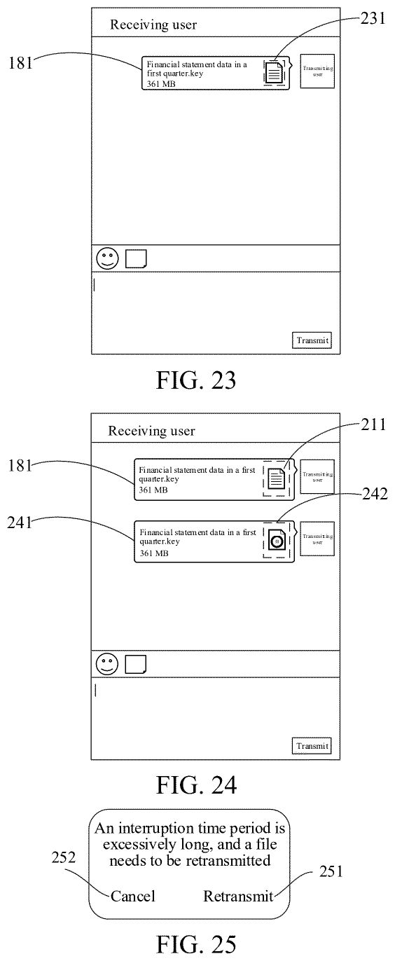

After operation S1703, when the transmitting terminal completes transmitting of the target file, the file transmission page is displayed; and the transmitting progress identifier on the file transmission page is replaced with a complete identifier. As shown in FIG. 23, the file transmission page includes the completion identifier 231 and the file name of the target file is, for example, “financial statement data in a first quarter.key”.

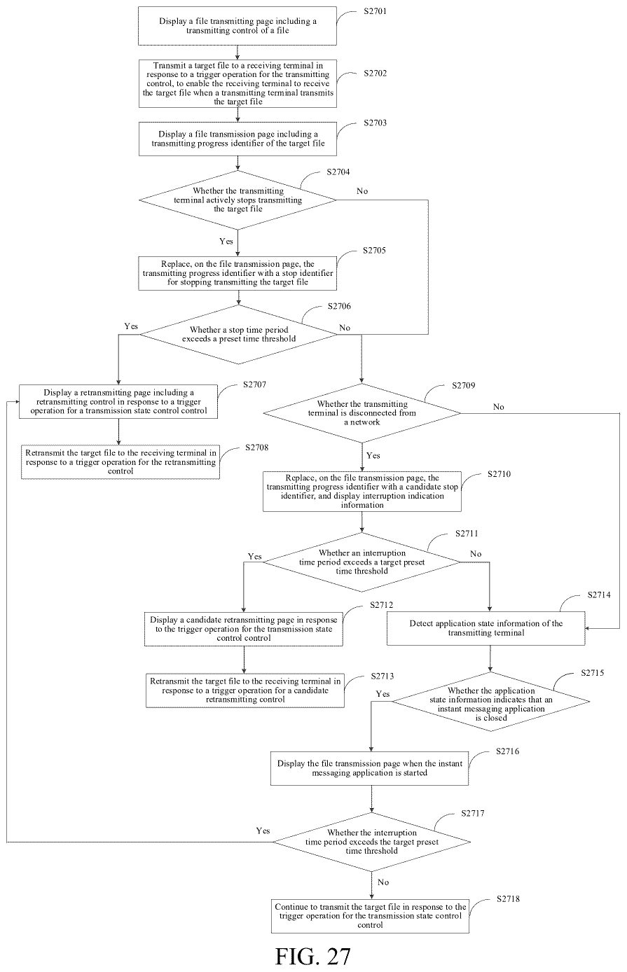

For operation S1701 and operation S1703, descriptions are further provided herein by using an example in which the target file is the text file, as shown in FIG. 27, and details are shown in operation S2701 to operation S2718.

S2701: Display a file transmitting page including a transmitting control of a file.

S2702: Transmit a target file to a receiving terminal in response to a trigger operation for the transmitting control, to enable the receiving terminal to start, in a process in which a transmitting terminal transmits the target file, to download content of the target file that has been transmitted by the transmitting terminal.

S2703: Display a file transmission page including a transmitting progress identifier of the target file.

S2704: Determine whether the transmitting terminal actively stops transmitting the target file;
for operation S2704, when the transmitting terminal transmits the target file, and in response to a trigger operation for a transmission state control control, the transmitting terminal stops transmitting the target file to the receiving terminal, it may be determined that the transmitting terminal actively suspends transmitting the target file, and perform operation S2705; and when the transmitting terminal does not stop transmitting the target file to the receiving terminal in response to the trigger operation for the transmission state control control, it may be determined that the transmitting terminal does not actively suspend transmitting the target file, and perform operation S2709.

S2705: Replace, on the file transmission page, the transmitting progress identifier with a stop identifier for stopping transmitting the target file.

S2706: Determine whether a stop time period in which the target file stops to be transmitted to the receiving terminal exceeds a preset time threshold;
when the stop time period exceeds the preset time threshold, for example, five days, perform operation S2707; and when the stop time period does not exceed the preset time threshold, perform operation S2709.

S2707: Display a retransmitting page including a retransmitting control in response to the trigger operation for the transmission state control control.

S2708: Retransmit the target file to the receiving terminal in response to a trigger operation for the retransmitting control.

S2709: Determine whether the transmitting terminal is disconnected from a network;
when the transmitting terminal is disconnected from the network, perform operation S2710; and when the transmitting terminal is not disconnected from the network, perform operation S2714.

S2710: Replace, on the file transmission page, the transmitting progress identifier with a candidate stop identifier, and display interruption indication information.

S2711: Determine whether an interruption time period in which the transmitting terminal interrupts transmitting of the target file exceeds a target preset time threshold; when the interruption time period in which the transmitting terminal interrupts transmitting of the target file exceeds the target preset time threshold, perform operation S2712; and when the interruption time period in which the transmitting terminal interrupts transmitting of the target file does not exceed the target preset time threshold, perform operation S2714.

S2712: Display a candidate retransmitting page in response to the trigger operation for the transmission state control control.

S2713: Retransmit the target file to the receiving terminal in response to the trigger operation for the candidate retransmitting control.

S2714: Detect application state information of the transmitting terminal.

S2715: Determine whether the application state information indicates that an instant messaging application is closed; when the application state information indicates that the instant messaging application is closed, perform operation S2716; and when the application state information does not indicate that the instant messaging application is closed, continue to transmit the target file.

S2716: Display the file transmission page when the instant messaging application is started.

S2717: Determine whether the interruption time period in which the transmitting terminal interrupts transmitting of the target file exceeds the target preset time threshold; when the interruption time period in which the transmitting terminal interrupts transmitting of the target file exceeds the target preset time threshold, return to perform operation S2707; and when the interruption time period in which the transmitting terminal interrupts transmitting of the target file does not exceed the target preset time threshold, perform operation S2718.

S2718: Continue to transmit the target file in response to the trigger operation for the transmission state control control.

In this embodiment of this disclosure, the file transmitting page may be displayed, and the file transmitting page includes an identifier of the target file and a transmitting control for the target file; the target file is transmitted to the receiving terminal in response to the trigger operation for the transmitting control, to enable the receiving terminal to start, in a process in which the transmitting terminal transmits the target file, to download content of the target file that has been transmitted by the transmitting terminal; and the file transmission page of the target file is displayed, where the file transmission page includes the transmitting progress identifier of the target file. In this embodiment of this disclosure, the transmitting terminal may transmit the target file to the receiving terminal in response to the trigger operation for the transmitting control, to enable the receiving terminal to receive the target file when the transmitting terminal transmits the target file, to improve file transmission efficiency between the transmitting terminal and the receiving terminal. Then, in this embodiment of this disclosure, the transmitting progress identifier of the target file may be further displayed on the file transmission page, to enable a user to sense a transmitting progress of the target file, thereby improving file transmission experience of the user.

According to the method described in the foregoing embodiment, the following further provides detailed descriptions by using an example.

In this embodiment, the file transmission apparatus is integrated in the electronic device, and the electronic device is a target server.

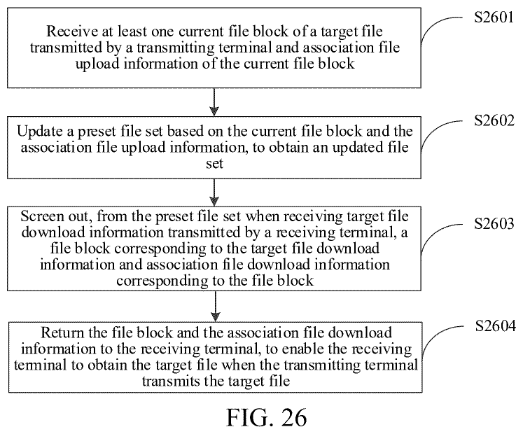

As shown in FIG. 26, a specific procedure of the file transmission method is as shown in operation S2601 to operation S2604.

S2601: Receive at least one current file block of a target file transmitted by a transmitting terminal and association file upload information of the current file block.

The target file may include a plurality of candidate file blocks, and the current file block may refer to a file block that is being uploaded by the transmitting terminal in the plurality of candidate file blocks. The transmitting terminal may upload the plurality of current file blocks in parallel at a time.

For details of the association file upload information, refer to descriptions in the above embodiments of the disclosure.

Before operation S2601, the target server may receive a file upload request that is transmitted by the transmitting terminal and that is for the target file. Then, a file identifier of the target file is returned to the transmitting terminal based on the file upload request, to enable the transmitting terminal to transmit a file message including the file identifier to the receiving terminal. When the receiving terminal receives the file message, a file display control corresponding to the file message is displayed on a displayed file message display page.

When the transmitting terminal transmits the file message including the file identifier to the receiving terminal, the transmitting terminal transmits the file message to a message server, and then the receiving terminal may pull the file message from the message server. The message server may refer to a server configured to at least receive and transmit the file message.

After the transmitting terminal obtains the file identifier from the target server, that the transmitting terminal transmits the current file block of the target file to the target server and that the transmitting terminal transmits the file message to the message server may be parallel.

S2602: Update a preset file set based on the current file block and association file upload information, to obtain an updated file set.

Operation S2601 and operation S2602 are continuously repeated processes. For example, after operation S2602, the updated file set may be used as the preset file set, and receiving of the at least one current file block of the target file transmitted by the transmitting terminal and the association file upload information of the current file block is performed again, until the transmitting terminal stops transmitting the current file block and the association file upload information to the target server, to obtain the updated file set.

In this embodiment of this disclosure, the target server may include a cache server and a storage server. For detailed explanations of the cache server and the storage server, refer to the descriptions in the above embodiments of the disclosure, and details are not described herein again.

### Cache Server

In this disclosure, the cache server may be configured to receive the at least one current file block of the target file transmitted by the transmitting terminal and the association file upload information of the current file block.

Then, for operation S2602, the target server may update the preset file set based on the current file block and the association file upload information by using the cache server, to obtain the updated file set.

The preset file set includes a preset file block subset and a preset transmission information subset. The preset file block subset may refer to a file block set that is used by the cache server to store the current file block transmitted by the transmitting terminal. The preset transmission information subset may refer to a set that is used by the cache server to store the association file upload information transmitted by the transmitting terminal.

A specific manner of the operation of “updating the preset file set based on the current file block and the association file upload information by using the cache server, to obtain the updated file set” may be: updating the preset file block subset based on the current file block by using the cache server, to obtain an updated file block subset; updating the preset transmission information subset according to the association file upload information by using the cache server, to obtain an updated transmission information subset; and generating the updated file set based on the updated file block subset and the updated transmission information subset.

In this disclosure, the current file block may be stored in the preset file block subset, to obtain the updated file block subset. After being stored, the current file block may be referred to as a file block. Based on this, when downloading the target file, the receiving terminal may download the file block from the preset file block subset of the target server.

The association file upload information may be stored into the preset transmission information subset, to obtain the updated transmission information subset. In some examples, the association file upload information may be stored into the preset transmission information subset, and historical association file upload information in the preset transmission information subset is replaced with the association file upload information, to obtain the updated transmission information subset.

The historical association file upload information may be association file upload information within a historical time period.

In this disclosure, after the cache server is configured to receive the at least one current file block of the target file transmitted by the transmitting terminal and the association file upload information of the current file block, the cache server may be configured to transmit the current file block and the association file upload information to the storage server.

### Storage Server

After the storage server receives the current file block and the association file upload information that are transmitted by the cache server, the target server may transmit the current file block and the association file upload information to the storage server by using the cache server; and the target server may receive the current file block and the association file upload information by using the storage server, and update a preset file data set based on the current file block and the association file upload information, to obtain an updated file data set.

The updated file data set includes a preset binding data subset and a preset upload information subset. The preset binding data subset may be a set configured for storing the current file block and reference upload information of the current file block; and the preset upload information subset may be a set configured for storing the association file upload information.

Association upload information of a candidate file block that is included in the association file upload information includes various types of information, for example, (1) association upload information of a candidate file block strongly related to the current file block; (2) association upload information of a candidate file block weakly related to the current file block; and (3) association upload information of the current file block.

The reference upload information may include (1) the association upload information of the candidate file block strongly related to the current file block; and (2) the association upload information of the current file block. For details of the association upload information, refer to explanations in the above embodiments of the disclosure, and details are not described herein again.

When splitting the target file, the transmitting terminal may split the target file into a plurality of independent candidate file blocks according to a size of 1 MB, and then the transmitting terminal may group 128 candidate file blocks into one block. When the candidate file block and the current file block are located in the same block, this case may be referred to as that the candidate file block is strongly related to the current file block. When the candidate file block and the current file block are not located in the same block, for example, the candidate file block and the current file block are respectively located in two adjacent blocks, this case may be referred to as that the candidate file block is weakly related to the current file block.

In this disclosure, in each block, reference upload information corresponding to the block may be represented by using 16 bytes. The association file upload information may include reference upload information of a block in which the current file block is located and reference upload information of an adjacent block of the current file block, or include only reference upload information of a block in which the current file block is located.

When uploading the current file block, the transmitting terminal may transmit both the current file block and the association file upload information of the current file block to the target server. However, because data is easily unstable if the association file upload information occupies an excessively long byte, based on this, in this disclosure, a case in which the association file upload information includes at most reference upload information corresponding to three blocks may be set.

For example, when the transmitting terminal uploads a 100^{th} current file block, association file upload information carried in the 100^{th} current file block includes reference upload information of 16 bytes that corresponds to a 1^{st} block. When the transmitting terminal uploads a 200^{th} current file block, association file upload information carried in the 200^{th} current file block includes: (1) the reference upload information of 16 bytes that corresponds to the 1^{st} block; and (2) reference upload information of 16 bytes that corresponds to a 2^{nd} block.

When the transmitting terminal uploads a 300^{th} current file block, association file upload information carried in the 300^{th} current file block includes: (1) the reference upload information of 16 bytes that corresponds to the 1^{st} block; (2) the reference upload information of 16 bytes that corresponds the 2^{nd} block; and (3) reference upload information of 16 bytes that corresponds to a 3^{rd} block.

The rest is deduced by analogy. When the transmitting terminal uploads an 800^{th} current file block, association file upload information carried in the 800^{th} current file block includes: (1) reference upload information of 16 bytes that corresponds to a 5^{th} block; (2) reference upload information of 16 bytes that corresponds to a 6^{th} block; and (3) reference upload information of 16 bytes that corresponds to a 7^{th} block.

In this embodiment of this disclosure, after receiving the current file block and the association file upload information, the storage server may update the preset file data set. In some examples, a manner of the operation of “updating a preset file data set based on the current file block and the association file upload information, to obtain an updated file data set” may be: extracting, from the association file upload information by using the storage server, reference upload information corresponding to the current file block, and binding the current file block to the reference upload information, to obtain file block binding data; updating the preset binding data subset based on the file block binding data by using the storage server, to obtain an updated binding data subset; updating the preset upload information subset based on the association file upload information by using the storage server, to obtain an updated upload information subset; and determining the updated file data set based on the updated upload information subset and the updated binding data subset.

The storage server may be configured to store the file block binding data in the preset binding data subset, and replace historical file block binding data in the preset data subset, to update the preset binding data subset; and the storage server may be configured to store the association file upload information into the preset upload information subset, and replace historical association file upload information in the preset upload information subset, to update the preset upload information subset.

The historical file block binding data may be file block binding data in a historical time period.

The operation of “updating the preset upload information subset based on the association file upload information by using the storage server, to obtain an updated upload information subset” is described by using an example herein. For example, before the preset upload information subset is updated, the target server may pre-establish a block index in the preset upload information subset. Each block index includes index information corresponding to a current block, and the index information may include preset reference upload information corresponding to the current block in which the current file block is located and preset reference upload information of a next block of the current block.

For example, a 1^{st} block index includes preset reference upload information of a 1^{st} block and preset reference upload information of a 2^{nd} block. A 2^{nd} block index includes the preset reference upload information of the 2^{nd} block and preset reference upload information of a 3^{rd} block. A 3^{rd} block index includes the preset reference upload information of the 3^{rd} block and preset reference upload information of a 4^{th} block. The rest is deduced by analogy.

The preset reference upload information may include preset state information corresponding to the candidate file block and candidate sequence information corresponding to the candidate file block. The preset state information may be set to 0, which indicates that the candidate file block has not been uploaded. During the first update, the preset state information is 0. In another round of update after the first update, the preset state information may not be 0.

Then, a process of updating the upload information subset may be, for example, that when a 100^{th} current file block is uploaded, a 1^{st} block index needs to be updated. The 1^{st} block index includes preset state information of the 1^{st} block and preset state information of the 2^{nd} block. In this disclosure, the 1^{st} block index may be updated based on association file upload information of the 100^{th} current file block, to obtain an updated 1^{st} block index. In index information of the updated 1^{st} block index, the preset state information of the 1^{st} block has been updated, to obtain updated state information. Under normal conditions, the updated state information is all 1; and the preset state information of the 2^{nd} block is all 0.

When a 200^{th} current file block is uploaded, the updated 1^{st} block index is used as the 1^{st} block index, the updated state information is used as the preset state information, and the 1^{st} block index and the 2^{nd} block index are updated. When the 200^{th} current file block is uploaded, the preset state information of the 2^{nd} block is updated. In this way, it can be ensured that before downloading a file block of the 2^{nd} block, the receiving terminal can download a file block of the 1^{st} block, and download reference download information of the 3^{rd} block, to continue to download the file block of the target file.

When a 300^{th} current file block is uploaded, the updated 1^{st} block index is used as the 1^{st} block index, the updated 2^{nd} block index is used as the 2^{nd} block index, the updated state information is used as the preset state information, and then the 1^{st} block index, the 2^{nd} block index, and the 3^{rd} block index are updated. The rest is deduced by analogy.

S2603: Determine, from the preset file set when receiving target file download information transmitted by a receiving terminal, a file block corresponding to the target file download information and association file download information corresponding to the file block.

In operation S2603, a manner of the operation of “determining, from the preset file set, a file block corresponding to the target file download information and association file download information corresponding to the file block” may be: extracting sequence information of a to-be-downloaded file block from the target file download information; extracting a file block corresponding to the sequence information from the preset file block subset in the preset file set; and extracting association file download information corresponding to the sequence information from the preset transmission information subset in the preset file set.

The association file download information may include the reference download information of the block in which the file block is located and the reference download information of the adjacent block of the block in which the file block is located, or the reference download information of the block in which the file block is located.

The reference download information may be corresponding reference upload information when the transmitting terminal uploads the current file block.

S2604: Return the file block and the association file download information to the receiving terminal, to enable the receiving terminal to obtain the target file when the transmitting terminal transmits the target file.

Operation S2603 and operation S2604 are continuously repeated processes. After operation S2604, in this disclosure, the target file download information may be generated based on the association file download information, and the operation of determining, from the preset file set when the target file download information transmitted by the receiving terminal is received, a file block corresponding to the target file download information and the association file download information corresponding to the file block is performed again, until each piece of association file download information is the target file download information, to enable the receiving terminal to receive a file block corresponding to each piece of target file download information that is returned by the target server.

The association file download information may be used as initial file download information, and then the target file download information may be generated based on the initial file download information. In this disclosure, sequence information of a file block whose current transmission state is an uploaded state may be identified from the initial file download information, and the sequence information of the file block in the uploaded state is used as the target file download information. Alternatively, the initial file download information is used as the target file download information.

In this embodiment of this disclosure, a repeating process of operation S2601 and operation S2602 and a repeating process of operation S2603 and operation S2604 may be parallel processes.

Operation S2601 and operation S2604 are described by using an example in which the receiving terminal downloads the target file from the storage server.

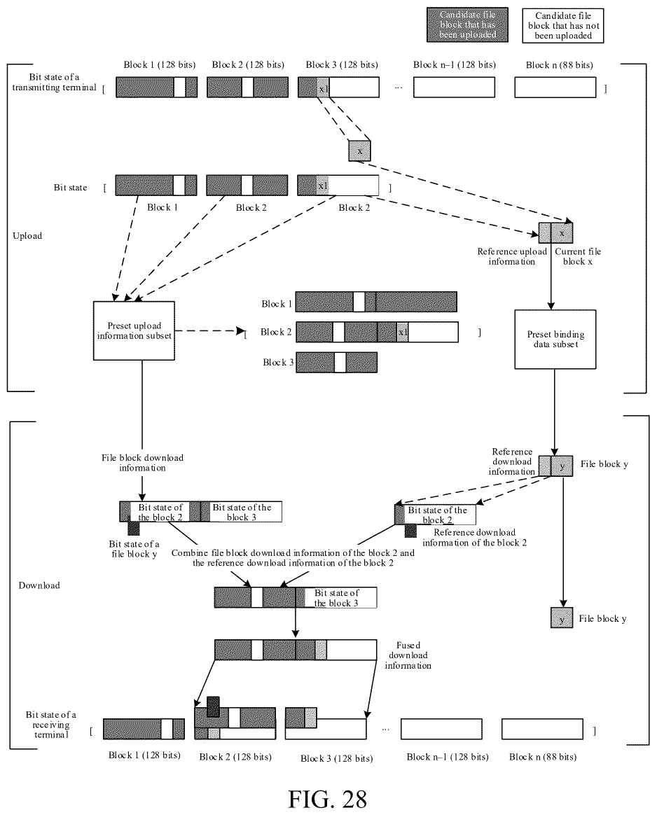

As shown in FIG. 28, the transmitting terminal may split the target file into a plurality of candidate file blocks, and group the candidate file blocks into n blocks, such as a block 1, a block 2, . . . , and a block n. In this disclosure, 128 candidate file blocks may be used as one block, each candidate file block has corresponding association upload information, and the association upload information of each candidate file block may be represented by using one bit state. Based on this, each block may have corresponding 128 bit states, such as 1 or 0. Because the block n is a last block, and the block n includes 88 candidate file blocks, based on this, the block n may correspond to 88 bit states. In this example, the association upload information is represented by using a bit state. When the candidate file block has been uploaded, a corresponding bit state is 1, and when the candidate file block has not been uploaded, a corresponding bit state is 1.

As shown in FIG. 28, for example, the transmitting terminal is currently transmitting a current file block x in an upload block 3 to the cache server of the target server, where x1 represents a bit state of the current file block. When transmitting the current file block x, the transmitting terminal carries association file upload information corresponding to the current file block. For example, the association file upload information includes a bit state of the block 1, a bit state of the block 2, and a bit state of the block 3. Then, the cache server transmits the current file block x, the bit state of the block 1, the bit state of the block 2, and the bit state of the block 3 to the storage server.

After receiving the current file block x, the bit state of the block 1, the bit state of the block 2, and the bit state of the block 3, the storage server may bind the current file block x in the block 3 to the bit state of the block 3, to obtain file block binding data, and update a preset binding data subset in the storage server, to obtain an updated binding data subset. A preset upload information subset of the storage server is updated according to the bit state of the block 1, the bit state of the block 2, and the bit state of the block 3, to obtain an updated upload information subset.

In a process in which the transmitting terminal stores the target file into the target server, the receiving terminal may request the target server to download the target file. When the receiving terminal cannot request the target file from the cache server of the target server, the receiving terminal may request the target file from the storage server.

For example, when requesting a 1^{st} file block from the storage server, the receiving terminal may transmit a file download request carrying a file identifier to the storage server, to enable the storage server to return the initial file download information and the 1^{st} file block based on the file identifier.

After requesting the 1^{st} file block from the storage server, the receiving terminal may continue to request a file block. For example, the receiving terminal may download a file block y in the second block from the storage server.

The receiving terminal may transmit target file download information of the file block y to the storage server. After receiving the target file download information, the storage server may obtain reference download information of the file block y and the file block y, for example, the bit state of the block 2, from the updated binding data subset based on the target file download information, and the file block download information obtained from the preset upload information subset, for example, the bit state of the block 2 and the bit state of the block 3. Then, the storage server may transmit the current file block x, the reference download information, and the file block download information together to the receiving terminal.

After receiving the current file block x, the reference download information, and the file block download information, the receiving terminal may fuse the reference download information and the file block download information, to obtain fused download information. Then, target file download information may be generated based on the fused download information. Then, the target file download information is transmitted to the storage server, to request the file block and the association file download information.

The fused download information may be used as the target file download information, or sequence information of a file block whose current transmission state is an uploaded state is identified from the fused download information, and the sequence information of the file block in the uploaded state is used as the target file download information.

The receiving terminal may further update a local bit state of the receiving end by using the fused download information, to obtain an updated bit state. As shown in FIG. 28, the local bit state may be set according to a bit state of each block of a transmitting terminal corresponding to the receiving terminal.

In this embodiment of this disclosure, the target server may be used as a transfer station of the target file, so that the receiving terminal can download the target file in a process in which the transmitting terminal uploads the target file, to improve file transmission efficiency.

According to the method described in the foregoing embodiment, detailed descriptions are further provided by using an example in which the target server includes the cache server.

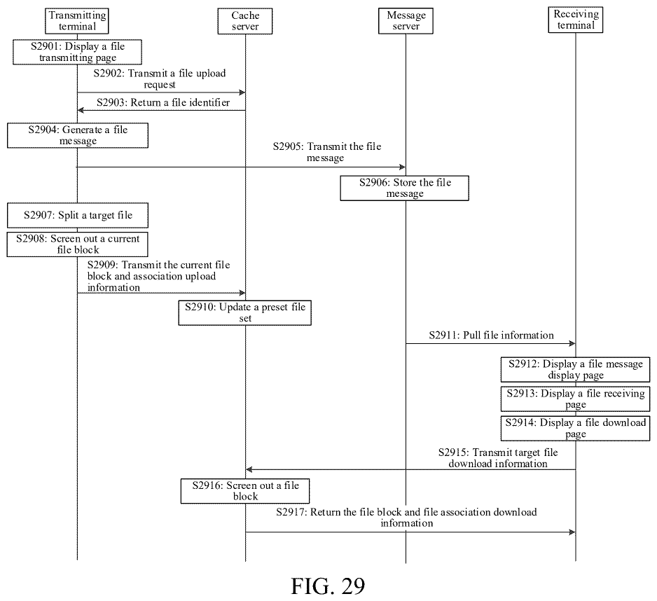

As shown in FIG. 29, a specific procedure of the file transmission method is as shown in operation S2901 to operation S2917.

S2901: A transmitting terminal displays a file transmitting page including an identifier of a target file and a transmitting control for the target file.

In some examples, the transmitting terminal may display a file transmission page, and the file transmission page includes a file selection control; obtain a plurality of candidate files in response to a trigger operation for the file selection control; and display, in response to a selection operation for the candidate files, a file transmitting page including the identifier of the target file and the transmitting control for the target file.

S2902: The transmitting terminal transmits a file upload request to a cache server in response to a trigger operation for the transmitting control.

For operation S2902, the transmitting terminal transmits the file upload request to the cache server in response to the trigger operation for the transmitting control, to transmit the target file to the cache server, so that the target file may be transmitted to a receiving terminal through the cache server, to enable the receiving terminal to receive the target file when the transmitting terminal transmits the target file.

After operation S2902, the transmitting terminal may further display a file transmission page of the target file, where the file transmission page includes a transmitting progress identifier of the target file.

After the operation of “displaying a file transmission page of the target file”, in this disclosure, transmitting of the target file to the receiving terminal may be further stopped. In some examples, when transmitting the target file, the transmitting terminal stops transmitting the target file to the receiving terminal in response to a trigger operation for a transmission state control control; and replaces the transmitting progress identifier with a stop identifier for stopping transmitting the target file.

In this disclosure, after the target file stops being transmitted to the receiving terminal, the target file may be invalid. In this case, the target file may be further retransmitted. In some examples, when a stop time period in which transmitting of the target file to the receiving terminal stops exceeds a preset time threshold, a retransmitting page is displayed in response to the trigger operation for the transmission state control control. The retransmitting page includes a retransmitting control; and the target file is retransmitted to the receiving terminal in response to the trigger operation for the retransmitting control.

S2903: The cache server receives the file upload request, and returns a file identifier to the transmitting terminal based on the file upload request.

S2904: The transmitting terminal receives the file identifier, and generates a file message based on the file identifier.

S2905: The transmitting terminal transmits the file message including the file identifier to a message server.

S2906: The message server receives and stores the file message.

S2907: The transmitting terminal splits the target file, to obtain at least one candidate file block.

In some examples, a manner of the operation of “splitting the target file, to obtain at least one candidate file block” may be: obtaining a preset splitting parameter; and splitting the target file based on the preset splitting parameter, to obtain the at least one candidate file block.

S2908: The transmitting terminal determines at least one current file block from the candidate file blocks, and obtains association file upload information corresponding to the current file block.

A manner of the operation of “obtaining association file upload information corresponding to the current file block” may be: obtaining preset file transmission information corresponding to the current file block, and detecting upload state information of an uploaded target file block in the candidate file blocks; and updating the preset file transmission information based on the upload state information, to obtain the association file upload information corresponding to the current file block.

S2909: The transmitting terminal transmits the current file block and the association file upload information to the cache server.

S2910: The cache server receives the current file block and the association file upload information, and updates a preset file set based on the current file block and the association file upload information, to obtain an updated file set.

In operation S2910, the preset file set includes a preset file block subset and a preset transmission information subset; and a manner of updating the preset file set based on the current file block and the association file upload information by using the cache server, to obtain the updated file set may be: updating the preset file block subset based on the current file block by using the cache server, to obtain an updated file block subset; updating the preset transmission information subset according to the association file upload information by using the cache server, to obtain an updated transmission information subset; and generating the updated file set based on the updated file block subset and the updated transmission information subset.

S2911: The receiving terminal pulls the file message including the file identifier from the message server.

S2912: The receiving terminal displays a file message display page including a file display control corresponding to the file message.

S2913: The receiving terminal displays, in response to a trigger operation for the file display control, a file receiving page including a receiving control of the target file.

S2914: The receiving terminal displays a file download page of the target file in response to a trigger operation for the receiving control.

The file download page includes file transmitting state information, that is, the file download page displays the file transmitting state information, and the file transmitting state information indicates that the transmitting terminal is transmitting the target file.

In this embodiment of this disclosure, after the file download page of the target file is displayed, the transmitting terminal may stop transmitting the target file. Correspondingly, the receiving terminal responds to this case. In some examples, when stopping transmitting the target file, the transmitting terminal displays a file receiving termination page, where the file receiving termination page includes a page return control and transmission stopping indication information of the target file; and displays the file message display page in response to a trigger operation for the page return control, and displays a first file state indication identifier on the file message display page, where the first file state indication identifier indicates that transmission of the target file is terminated.

In this embodiment of this disclosure, after the file download page of the target file is displayed, downloading of the target file may be further canceled, and then downloading of the target file may be further continued. For example, the file download page includes a cancel control. Based on this, the receiving terminal may display the file receiving page in response to a trigger operation for the cancel control; and continue to download the target file in response to the trigger operation for the receiving control on the file receiving page.

S2915: The receiving terminal transmits target file download information to the cache server.

In some examples, a manner in which the receiving terminal transmits the target file download information to the cache server may be: obtaining initial file download information of the target file, and using the initial file download information as the target file download information; and transmitting the target file download information to the cache server.

A manner of the operation of “obtaining initial file download information of the target file” may be: obtaining a file identifier of the target file; transmitting, to the target server, a file download request carrying the file identifier, to enable the target server to return the initial file download information based on the file identifier; and receiving the initial file download information of the target file.

In some examples, a manner of the operation of “obtaining a file identifier of the target file” may be: obtaining a file message of the target file transmitted by the transmitting terminal; and extracting the file identifier of the target file from the file message.

In some examples, a manner of the operation of “transmitting, to the target server, a file download request carrying the file identifier, to enable the target server to return the initial file download information based on the file identifier” may be: transmitting, to the cache server, the file download request carrying the file identifier, to enable the cache server to query initial file download information corresponding to the file identifier; transmitting the file download request carrying the file identifier to the storage server when initial file download information returned by the cache server is not received, to enable the storage server to return the initial file download information based on the file identifier; and receiving the initial file download information returned by the storage server.

S2916: The cache server determines, from the preset file set, a file block corresponding to the target file download information and association file download information corresponding to the file block.

S2917: The cache server returns the file block and the association file download information to the receiving terminal, to enable the receiving terminal to obtain the target file when the transmitting terminal transmits the target file.

Operation S2905 and operation S2907 may be performed in parallel. Operation S2911 may be performed after operation S2905 and performed before or after any operation before operation S2911. Operation S2914 and operation S2915 may be performed in parallel.

For operation S2901 to operation S2917, details are further described herein.

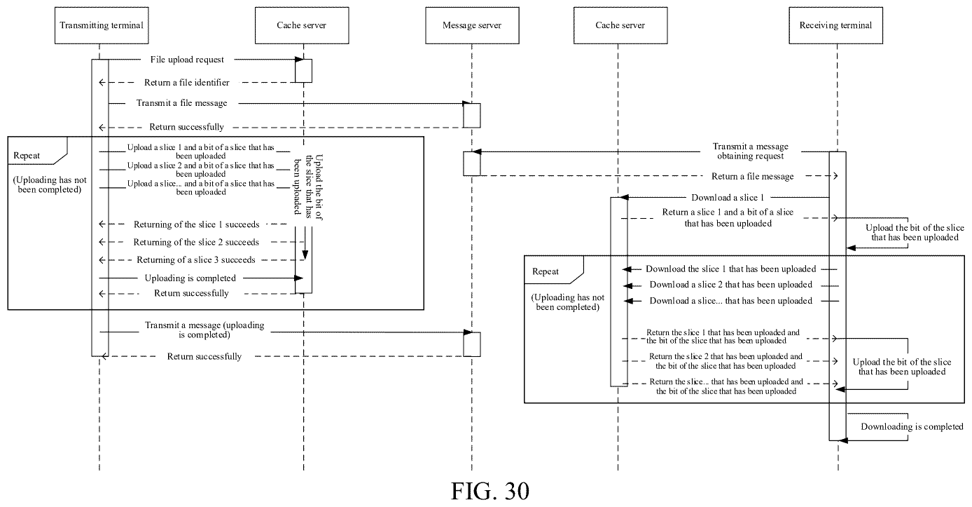

As shown in FIG. 30, the transmitting terminal displays the file transmitting page including the identifier of the target file and the transmitting control for the target file; and the transmitting terminal transmits the file upload request to the cache server in response to the trigger operation for the transmitting control. Then, the cache server receives the file upload request, and returns the file identifier to the transmitting terminal based on the file upload request. The transmitting terminal receives the file identifier, and generates the file message based on the file identifier. Then, the transmitting terminal transmits the file message including the file identifier to the message server. After receiving the file message, the message server may return success information to the transmitting terminal.

The transmitting terminal may transmit the target file to the cache server. In some examples, the transmitting terminal may split the target file, to obtain the at least one candidate file block. Then, the transmitting terminal determines at least one current file block from the candidate file blocks, and obtains association file upload information corresponding to the current file block. For example, the transmitting terminal determines the at least one current file block from the candidate file blocks. The current file block may be referred to as a slice. For example, the current file block may include a slice 1 and a slice 2 shown in FIG. 30. The transmitting terminal may further obtain a bit state of an uploaded slice, and use the bit state of the uploaded slice as the association file upload information corresponding to the current file block. The bit state may be recorded as a bit in this disclosure.

The transmitting terminal may transmit, in parallel, the slice 1 and a bit of a slice that has been uploaded before the slice 1, and the slice 2 and a bit of a slice that has been uploaded before the slice 2 to the cache server. When receiving the slice 1 and the bit of the slice that has been uploaded before the slice 1, and the slice 2 and the bit of the slice that has been uploaded before the slice 2, the cache server updates the preset file set, and then may separately return success information to the transmitting terminal.

The rest is deduced by analogy. The transmitting terminal may continuously and repeatedly transmit a slice and a bit of a slice that has been uploaded before the slice to the cache server, to enable the cache server to update the preset file set, until all slices of the target file are transmitted to the cache server. When completing transmitting of all the slices of the target file to the cache server, the transmitting terminal transmits a message indicating that uploading is completed to the cache server. When receiving the message indicating that uploading is completed, the cache server returns a success message to the transmitting terminal.

Certainly, when a network is interrupted, or the transmitting terminal stops transmitting the target file, the transmitting terminal may stop transmitting the target file.

In a process in which the transmitting terminal transmits the slices to the cache server, the receiving terminal may transmit a message obtaining request to the message server, to request the file message of the target file. When receiving the message obtaining request, the message server returns the file message to the receiving terminal.

Then, the receiving terminal may generate the file download request based on the file identifier in the file message, and then request, based on the file download request, the cache server to download a 1^{st} slice of the target file. The cache server may return, based on the file identifier, the 1^{st} slice and initial file download information corresponding to the 1^{st} slice. The initial file download information may include a bit of a slice that has been uploaded by the transmitting terminal. After receiving the initial download information, the receiving terminal may update a local bit state based on the initial download information.

Then, the receiving terminal may use the initial file download information as the target file download information, and continue to request slices such as the slice 1 and the slice 2 from the cache server. Each time returning a slice to the receiving terminal, the cache server carries association file download information corresponding to the slice, and then may use the association file download information as the initial file download information and use the initial file download information as the target file download information, and continue to request a slice from the cache server. This process is repeated until all slices of the target file are completely downloaded.

Certainly, when the network is interrupted, or the receiving terminal stops receiving the target file, or the transmitting terminal stops transmitting the target file, the receiving terminal may stop downloading the target file.

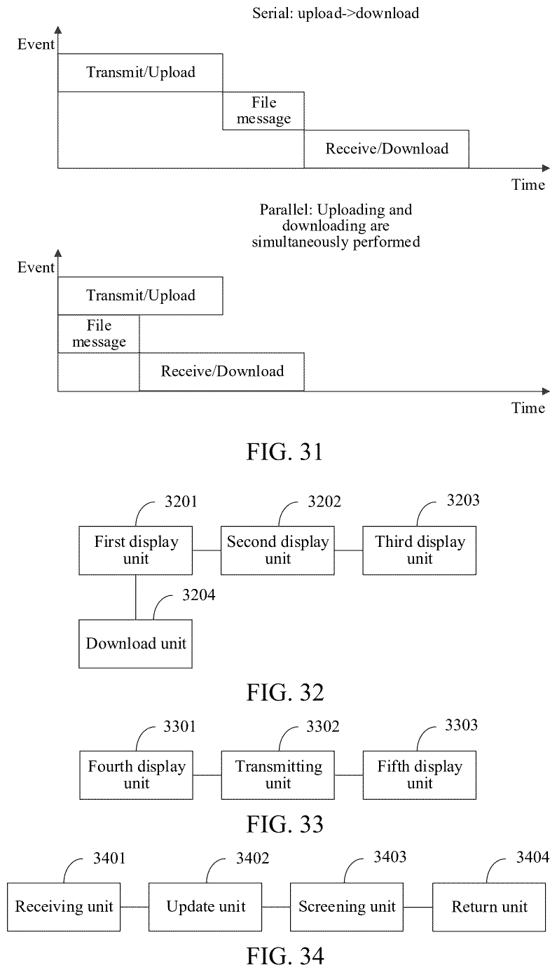

In this disclosure, file transmission efficiency between the receiving terminal and the transmitting terminal can be improved. As shown in FIG. 31, in this disclosure, uploading and downloading of the target file can be implemented in parallel. However, in the related art, uploading and downloading of the target file and transmission of the file message are performed in series. It can be learnt that, in the related art, transmission of the target file needs to take a longer period of time.

This disclosure supports downloading of the target file during uploading, which can effectively shorten a waiting time period from a time point at which a user receives the target file to a time point at which the user taps completion of downloading, and can also ensure consistency of message time sequences of the transmitting terminal and the receiving terminal.

In this disclosure, a file receiving page may be displayed, and a receiving control for a target file is displayed on the file receiving page, the target file being a file transmitted by a transmitting terminal to the receiving terminal; in response to a trigger operation for the receiving control, in a process in which the transmitting terminal transmits the target file, content of the target file that has been transmitted by the transmitting terminal starts to be downloaded, a file download page of the target file is displayed, and file transmitting state information is displayed on the file download page, the file transmitting state information indicating that the transmitting terminal is transmitting the target file; and download progress information indicating that partial content of the target file has been downloaded is displayed on the file download page when the transmitting terminal completes transmitting of the target file. In this disclosure, the receiving terminal can receive the target file in response to the trigger operation for the receiving control of the target file on the file receiving page, to enable the receiving terminal to receive the target file in real time in a process in which the transmitting terminal transmits the target file, to improve file transmission efficiency between the transmitting terminal and the receiving terminal. In this way, the receiving terminal may display the file transmitting state information on the file download page of the target file, to improve file transmission experience of a user. In this way, when the transmitting terminal completes transmitting of the target file, the receiving terminal may complete downloading of the partial content of the target file, to improve the file transmission efficiency between the transmitting terminal and the receiving terminal. In this way, the receiving terminal may display the download progress information indicating that the partial content of the target file has been downloaded, to improve the file transmission experience and enthusiasm of the user.

To better implement the foregoing method, the embodiments of this disclosure further provide a file transmission apparatus. The file transmission apparatus may be integrated in an electronic device, such as a receiving terminal, and the receiving terminal may include a tablet computer, a laptop computer and/or a personal computer, and the like.

For example, as shown in FIG. 32, the file transmission apparatus may include a first display unit 3201, a second display unit 3202, a third display unit 3203, and a download unit 304, which are as follows.

### First Display Unit 3201

The first display unit 3201 may be configured to display a file receiving page, and display a receiving control for a target file on the file receiving page, the target file being a file transmitted by a transmitting terminal to the receiving terminal.

For example, the first display unit 3201 may be further configured to display, when the transmitting terminal starts to transmit the target file, a file message display page corresponding to the target file, and display a file display control on the file message display page; and display the file receiving page in response to a trigger operation for the file display control.

### Second Display Unit 3202

The second display unit 3202 may be configured to: in response to a trigger operation for the receiving control, in a process in which the transmitting terminal transmits the target file, start to download content of the target file that has been transmitted by the transmitting terminal, display a file download page of the target file, and display file transmitting state information on the file download page, where the file transmitting state information indicates that the transmitting terminal is transmitting the target file.

For example, the second display unit 3202 may be further configured to display a file receiving termination page when the transmitting terminal stops transmitting the target file, the file receiving termination page including a page return control and transmission stopping indication information of the target file; and display the file message display page in response to a trigger operation for the page return control, and display a first file state indication identifier on the file message display page, the first file state indication identifier indicating that transmission of the target file is terminated.

For example, the file download page includes a cancel control. The second display unit 3202 may be further configured to display the file receiving page in response to a trigger operation for the cancel control; and continue to download the target file in response to the trigger operation for the receiving control on the file receiving page.

### Third Display Unit 3203

The third display unit 3203 may be configured to display, on the file download page when the transmitting terminal completes transmitting of the target file, download progress information indicating that partial content of the target file has been downloaded.

For example, the third display unit 3203 may be configured to display a file receiving suspension page when the receiving terminal suspends receiving the target file, the file receiving suspension page including a receiving continuation control; and continue to download the target file in response to a trigger operation for the receiving continuation control.

### (4) Download Unit 304

The download unit 304 may be configured to: in response to a trigger operation for the receiving control, in a process in which the transmitting terminal transmits the target file, start to download content of the target file that has been transmitted by the transmitting terminal.

The download unit 304 may be configured to obtain, in response to the trigger operation for the receiving control, initial file download information of the target file in the process in which the transmitting terminal transmits the target file; request, according to the initial file download information, a file block of the target file and association file download information corresponding to the file block from a target server, to enable the target server to return the file block and the association file download information; receive the association file download information and the file block, and use the association file download information as the initial file download information; and return to perform the operation of requesting, according to the initial file download information, the file block and the association file download information corresponding to the file block from the target server, until each piece of association file download information is the initial file download information, to obtain a plurality of file blocks corresponding to the target file, and combine the plurality of file blocks to obtain the target file.

For example, the download unit 304 may be configured to obtain a file identifier of the target file; transmit, to the target server, a file download request carrying the file identifier, to enable the target server to return the initial file download information based on the file identifier; and receive the initial file download information of the target file.

It can be learnt from the foregoing that, the first display unit 3201 in this embodiment of this disclosure may be configured to display a file receiving page, and display a receiving control for a target file on the file receiving page, the target file being a file transmitted by the transmitting terminal to the receiving terminal; the second display unit 3202 may be configured to: in response to a trigger operation for the receiving control, in a process in which the transmitting terminal transmits the target file, start to download content of the target file that has been transmitted by the transmitting terminal, display a file download page of the target file, and display file transmitting state information on the file download page, where the file transmitting state information indicates that the transmitting terminal is transmitting the target file; and the third display unit 3203 may be configured to display, on the file download page when the transmitting terminal completes transmitting of the target file, download progress information indicating that partial content of the target file has been downloaded. In this disclosure, the receiving terminal can receive the target file in response to the trigger operation for the receiving control of the target file on the file receiving page, to enable the receiving terminal to receive the target file in real time in a process in which the transmitting terminal transmits the target file, to improve file transmission efficiency between the transmitting terminal and the receiving terminal. In this way, the receiving terminal may display the file transmitting state information on the file download page of the target file, to improve file transmission experience of a user. In this way, when the transmitting terminal completes transmitting of the target file, the receiving terminal may complete downloading of the partial content of the target file, to improve the file transmission efficiency between the transmitting terminal and the receiving terminal. In this way, the receiving terminal may display the download progress information indicating that the partial content of the target file has been downloaded, to improve the file transmission experience and enthusiasm of the user.

To better implement the foregoing method, the embodiments of this disclosure further provide a file transmission apparatus. The file transmission apparatus may be integrated in an electronic device, such as a transmitting terminal, and the transmitting terminal may include a tablet computer, a laptop computer and/or a personal computer, and the like.

For example, as shown in FIG. 33, the file transmission apparatus may include a fourth display unit 3301, a transmitting unit 3302, and a fifth display unit 3303, which are as follows.

### (1) Fourth Display Unit 3301

The fourth display unit 3301 may be configured to display a file transmitting page, and display an identifier of a target file and a transmitting control for the target file on the file transmitting page.

### Transmitting Unit 3302

The transmitting unit 3302 may be configured to transmit the target file to a receiving terminal in response to a trigger operation for the transmitting control, to enable the receiving terminal to start, in a process in which a transmitting terminal transmits the target file, to download content of the target file that has been transmitted by the transmitting terminal.

For example, the transmitting unit 3302 may be configured to split the target file in response to the trigger operation for the transmitting control, to obtain at least one candidate file block; select at least one current file block from the candidate file blocks, and obtain association file upload information corresponding to the current file block, where the current file block is a non-uploaded file block; transmit the current file block and the association file upload information to a target server, to enable the target server to transmit a current file block of the target file to the receiving terminal based on the association file upload information; and return to perform the operation of determining the at least one current file block from the candidate file blocks, until each candidate file block is the current file block, to enable the target server to transmit each current file block of the target file to the receiving terminal.

### Fifth Display Unit 3303

The fifth display unit 3303 may be configured to display a file transmission page of the target file, the file transmission page including a transmitting progress identifier of the target file.

For example, the fifth display unit 3303 may be configured to stop, when the transmitting terminal transmits the target file, transmitting the target file to the receiving terminal in response to a trigger operation for the transmission state control control; and replace the transmitting progress identifier with a stop identifier for stopping transmitting the target file.

For example, the fifth display unit 3303 may be configured to continue, when the transmitting terminal stops transmitting the target file, to transmit the target file to the receiving terminal in response to the trigger operation for the transmission state control control; and replace the stop identifier with the transmitting progress identifier.

The fourth display unit 3301 in this embodiment of this disclosure may be configured to display a file transmitting page, and display an identifier of a target file and a transmitting control for the target file on the file transmitting page; the transmitting unit 3302 may be configured to transmit the target file to a receiving terminal in response to a trigger operation for the transmitting control, to enable the receiving terminal to start, in a process in which a transmitting terminal transmits the target file, to download content of the target file that has been transmitted by the transmitting terminal; and the fifth display unit 3303 may be configured to display a file transmission page of the target file, the file transmission page including a transmitting progress identifier of the target file. In this embodiment of this disclosure, the transmitting terminal may transmit the target file to the receiving terminal in response to the trigger operation for the transmitting control, to enable the receiving terminal to receive the target file when the transmitting terminal transmits the target file, to improve file transmission efficiency between the transmitting terminal and the receiving terminal. Then, in this embodiment of this disclosure, the transmitting progress identifier of the target file may be further displayed on the file transmission page, to enable a user to sense a transmitting progress of the target file, thereby improving file transmission experience of the user.

To better implement the foregoing method, the embodiments of this disclosure further provide a file transmission apparatus. The file transmission apparatus may be integrated in an electronic device, such as a server.

For example, as shown in FIG. 34, the file transmission apparatus may include a receiving unit 3401, an update unit 3402, a screening unit 3403, and a return unit 3404, which are as follows.

### (1) Receiving Unit 3401

The receiving unit 3401 may be configured to receive at least one current file block of a target file transmitted by a transmitting terminal and association file upload information of the current file block.

### Update Unit 3402

The update unit 3402 may be configured to update a preset file set based on the current file block and the association file upload information, to obtain an updated file set.

For example, the target server includes a cache server and a storage server. The update unit 3402 may be configured to update, based on the current file block and the association file upload information, the preset file set by using the cache server, to obtain the updated file set; transmit the current file block and the association file upload information to the storage server by using the cache server; and receive the current file block and the association file upload information by using the storage server, and update a preset file data set based on the current file block and the association file upload information, to obtain an updated file data set.

### Screening Unit 3403

The screening unit 3403 may be configured to determine, from the preset file set when receiving target file download information transmitted by a receiving terminal, a file block corresponding to the target file download information and association file download information corresponding to the file block; and

### Return Unit 3404

The return unit 3404 may be configured to return the file block and the association file download information to the receiving terminal, to enable the receiving terminal to obtain the target file when the transmitting terminal transmits the target file.

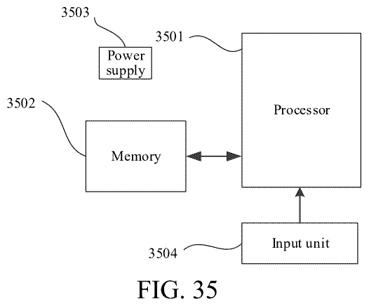

In addition, the embodiments of this disclosure further provide an electronic device. FIG. 35 is a schematic diagram of a structure of an electronic device according to an embodiment of the present disclosure. In some examples, the electronic device may include components such as a processor 3501 with one or more processing cores, a memory 3502 with one or more computer-readable storage medium, a power supply 3503, and an input unit 3504. It is noted that the electronic device structure shown in FIG. 35 does not constitute a limitation to the electronic device. The electronic device may include more or fewer components than those shown in the figure, or some components may be combined, or a different component deployment may be used.

The processor 3501 is a control center of the electronic device, which is connected to various parts of the entire electronic device by using various interfaces and lines, and by running or executing a software program and/or module stored in the memory 3502 and invoking data stored in the memory 3502, implements various functions of the electronic device and processes data. In some embodiments, the processor 3501 may include one or more processing cores. In some aspects, the processor 3501 may integrate an application processor and a modem, where the application processor mainly processes an operating system, a user interface, and an application and the like, and the modem mainly processes wireless communication. The foregoing modem processor may alternatively not be integrated into the processor 3501.

The memory 3502 may be configured to store a software program and a module, and the processor 3501 runs the software program and the module that are stored in the memory 3502, to perform various functional applications and data processing. The memory 3502 may mainly include a program storage area and a data storage area. The program storage area may store an operating system, an application needed by at least one function (such as a sound playing function and an image display function), and the like. The data storage area may store data created based on use of the electronic device, and the like. In addition, the memory 3502 may include a high speed random access memory, and may further include a non-volatile memory, such as at least one magnetic disk storage device, a flash memory, or another volatile solid storage device. Correspondingly, the memory 3502 may further include a memory controller, to provide access of the processor 3501 to the memory 3502.

The electronic device further includes the power supply 3503 for supplying power to the components. In some aspects, the power supply 3503 may be logically connected to the processor 3501 by using a power supply management system, thereby implementing functions such as charging, discharging, and power consumption management by using the power supply management system. The power supply 3503 may further include one or more direct current or alternating current power supplies, a re-charging system, a power failure detection circuit, a power supply converter or inverter, a power supply state indicator, and any other component.

The electronic device may further include the input unit 3504. The input unit 3504 may be configured to receive inputted numeric or character information and generate keyboard, mouse, joystick, optical, or trackball signal input related to user settings and function control.

Although not shown in the figure, the electronic device may further include a display unit, and the like. Details are not described herein again. In some examples, in this embodiment, the processor 3501 of the electronic device may load, according to the following instructions, executable files corresponding to processes of one or more applications into the memory 3502. The processor 3501 runs the applications stored in the memory 3502, to implement the various functions as follows:
displaying a file receiving page, and displaying a receiving control for a target file on the file receiving page, the target file being a file transmitted by a transmitting terminal to a receiving terminal; in response to a trigger operation for the receiving control, in a process in which the transmitting terminal transmits the target file, starting to download content of the target file that has been transmitted by the transmitting terminal, displaying a file download page of the target file, and displaying file transmitting state information on the file download page, the file transmitting state information indicating that the transmitting terminal is transmitting the target file; and displaying, on the file download page when the transmitting terminal completes transmitting of the target file, download progress information indicating that partial content of the target file has been downloaded.

For specific implementation of the foregoing operations, reference may be made to the foregoing embodiments. Details are not described herein again.

It is noted that, all or some of the operations in the methods in the foregoing embodiments may be completed by a computer program, or may be completed by controlling related hardware through a computer program. The computer program may be stored in a computer-readable storage medium and loaded and executed by a processor.

In view of this, embodiments of this disclosure provide a computer-readable storage medium, having a computer program stored therein. The computer program can be loaded by a processor, to perform any file transmission method provided in the embodiments of this disclosure.

For specific implementation of the foregoing operations, reference may be made to the foregoing embodiments. Details are not described herein again.

The computer-readable storage medium may include: a read-only memory (ROM), a random access memory (RAM), a magnetic disk, an optical disc, or the like.

Because with the instructions stored in the computer-readable storage medium, the operations of any file transmission method provided in the embodiments of this disclosure may be performed, beneficial effects that can be implemented by any file transmission method in the embodiments of this disclosure can be implemented. For details, refer to the foregoing embodiments. Details are not further described herein.

An aspect of this disclosure provides a computer program product or a computer program, the computer program product or the computer program including computer instructions, and the computer instructions being stored in the computer-readable storage medium. A processor of the electronic device reads the computer instructions from the computer-readable storage medium, and the processor executes the computer instructions, to enable the electronic device to perform the methods provided in various exemplary implementations in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Technical features of the foregoing embodiments may be combined in different manners to form other embodiments. For concise description, not all possible combinations of the technical features in the foregoing embodiments are described. However, provided that combinations of the technical features do not conflict with each other, the combinations of the technical features are considered as falling within the scope recorded in this specification.

The foregoing disclosure includes some embodiments of this disclosure which are not intended to limit the scope of this disclosure. Other embodiments shall also fall within the scope of this disclosure.

What is claimed is:

1. A file transmission method, the file transmission method comprising:
displaying, by a receiving terminal device, a file receiving page with a receiving control for a target file on the file receiving page;
in response to a trigger operation on the receiving control, during a process of an uploading of the target file by a transmitting terminal device, starting a downloading of content of the target file when the target file is being uploaded by the transmitting terminal device;
displaying a file download page of the target file with file transmitting state information on the file download page, the file transmitting state information indicating that the transmitting terminal device is uploading the target file; and
displaying, on the file download page and when the transmitting terminal device completes the uploading of the target file, download progress information indicating that partial content of the target file has been downloaded.

2. The file transmission method according to claim 1, wherein the displaying the file receiving page comprises:
displaying, when the transmitting terminal device starts to upload the target file, a file message display page for the target file, the file message display page including a file display control; and
displaying the file receiving page in response to a trigger operation for the file display control.

3. The file transmission method according to claim 2, further comprising:
displaying a file receiving termination page when the transmitting terminal device stops the uploading of the target file, the file receiving termination page comprising a page return control and transmission stopping indication information of the target file; and
displaying the file message display page in response to a trigger operation on the page return control, the file message display page including a first file state indication identifier, the first file state indication identifier indicating that the uploading of the target file is terminated.

4. The file transmission method according to claim 1, wherein the file download page comprises a cancel control, and the file transmission method further comprises:
displaying the file receiving page in response to a trigger operation on the cancel control; and
continuing to download the target file in response to a trigger operation on the receiving control of the file receiving page.

5. The file transmission method according to claim 2, further comprising:
displaying a file receiving suspension page when the receiving terminal device suspends the downloading of the target file, the file receiving suspension page comprising a receiving continuation control; and
continuing to download the target file in response to a trigger operation on the receiving continuation control.

6. The file transmission method according to claim 5, wherein the file receiving suspension page comprises a return control, and the file transmission method further comprises:
displaying the file message display page in response to a trigger operation on the return control; and
displaying a second file state indication identifier on the file message display page, wherein the second file state indication identifier indicates that the downloading of the target file is suspended.

7. The file transmission method according to claim 1, wherein the target file comprises a plurality of file blocks, and the starting the downloading comprises:
obtaining initial file download information of the target file during the process of the uploading of the target file by the transmitting terminal device;
requesting, according to the initial file download information of the target file, a file block of the target file and association file download information of the file block from a target server device, to cause the target server device to return the file block and the association file download information of the file block;
receiving the association file download information of the file block and the file block;
updating the initial file download information according to the association file download information of the file block to cause the initial file download information to indicate another file block in the target file for downloading;
repeating the requesting, the receiving and the updating, until the plurality of file blocks of the target file are received by the receiving terminal device; and
combining the plurality of file blocks to obtain the target file.

8. The file transmission method according to claim 7, wherein the obtaining the initial file download information of the target file comprises:
obtaining a file identifier of the target file;
transmitting, to the target server device, a file download request carrying the file identifier, to enable the target server device to return the initial file download information based on the file identifier; and
receiving the initial file download information of the target file.

9. The file transmission method according to claim 8, wherein the target server device comprises a cache server and a storage server, and the transmitting the file download request comprises:
transmitting, to the cache server, the file download request carrying the file identifier, to enable the cache server to query the initial file download information corresponding to the file identifier;
transmitting the file download request carrying the file identifier to the storage server when the initial file download information is not retuned by the cache server, to enable the storage server to return the initial file download information based on the file identifier; and
receiving the initial file download information that is returned by the storage server.

10. The file transmission method according to claim 7, wherein the initial file download information comprises file block download information and reference download information associated with the file block download information; and the requesting, the file block of the target file and the association file download information of the file block comprises:
fusing the file block download information and the reference download information, to obtain fused download information; and
requesting, based on the fused download information, the file block of the target file and the association file download information of the file block from the target server device.

11. The file transmission method according to claim 10, wherein the requesting, based on the fused download information, the file block and the association file download information of the file block from the target server device comprises:
identifying, from the fused download information, a current transmission state of a to-be-downloaded file block; and
when the current transmission state is an uploaded state, requesting, from the target server device, the to-be-downloaded file block.

12. A file transmission method, the file transmission method comprising:
displaying, by a transmitting terminal device, a file transmitting page with an identifier of a target file and a transmitting control for the target file on the file transmitting page;
uploading the target file in response to a trigger operation on the transmitting control, to enable a receiving terminal device to start, during a process that the transmitting terminal device is uploading the target file, to download content of the target file that is being uploaded by the transmitting terminal device; and
displaying a file transmission page of the target file, the file transmission page comprising a transmitting progress identifier indicating an uploading process of the target file.

13. The file transmission method according to claim 12, wherein the file transmission page further displays a control component for a transmission state control of the transmitting progress identifier, the file transmission method further comprises:
when the transmitting terminal device is uploading the target file,
pausing the uploading of the target file in response to a trigger operation on the control component for the transmission state control; and
replacing the transmitting progress identifier with a pause identifier indicating the pausing.

14. The file transmission method according to claim 13, the file transmission method further comprising:
when the transmitting terminal device pauses the uploading,
continuing to upload the target file in response to a trigger operation on the control component for the transmission state control; and
replacing the pause identifier with the transmitting progress identifier.

15. The file transmission method according to claim 13, the file transmission method further comprising:
displaying a retransmitting page in response to a trigger operation on the control component for the transmission state control when a pause duration exceeds a preset time threshold, the retransmitting page comprising a retransmitting control; and
reuploading the target file in response to a trigger operation on the retransmitting control.

16. The file transmission method according to claim 12, wherein the uploading the target file comprises:
splitting the target file in response to the trigger operation for the transmitting control, to obtain one or more candidate file blocks;
selecting a current file block from the one or more candidate file blocks, the current file block being a non-uploaded file block;
obtaining association file upload information of the current file block;
uploading the current file block and the association file upload information of the current file block to a target server, to enable the target server to transmit the current file block of the target file to the receiving terminal device based on the association file upload information; and
repeating the selecting, the obtaining and the uploading, until each of the one or more candidate file blocks are uploaded to the target server, to enable the target server to transmit each of the one or more candidate file blocks of the target file to the receiving terminal device.

17. The file transmission method according to claim 16, wherein the obtaining the association file upload information of the current file block comprises:
obtaining preset file transmission information of the current file block;
detecting upload state information of at least an uploaded target file block in the one or more candidate file blocks; and
updating the preset file transmission information based on the upload state information, to obtain the association file upload information of the current file block.

18. A file transmission method, the file transmission method comprising:
receiving, by a target server device, at least a current file block of a target file and association file upload information of the current file block that are uploaded by a transmitting terminal device;
updating a preset file set based on the current file block and the association file upload information of the current file block, to obtain an updated file set;
receiving target file download information that is transmitted by a receiving terminal device;
determining, from the updated file set, a file block, and association file download information of the file block according to the target file download information; and
transmitting the file block and the association file download information of the file block to the receiving terminal device, to enable the receiving terminal device to obtain the target file when the transmitting terminal device is uploading the target file.

19. The file transmission method according to claim 18, wherein:
the target server device comprises a cache server and a storage server;
the updating the preset file set comprises:
updating, based on the current file block and the association file upload information of the current file block, the preset file set by the cache server, to obtain the updated file set; and
the file transmission method further comprises:
transmitting the current file block and the association file upload information of the current file block to from the cache server to the storage server; and
updating, by the storage server, a preset file data set based on the current file block and the association file upload information, to obtain an updated file data set.

20. The file transmission method according to claim 19, wherein:
the updated file data set comprises a preset binding data subset and a preset upload information subset; and
the updating the preset file data set comprises:
extracting, by the storage server and from the association file upload information of the current file block, reference upload information of the current file block;
binding the current file block to the reference upload information to obtain file block binding data;
updating, by the storage server, the preset binding data subset based on the file block binding data to obtain an updated binding data subset;
updating, by the storage server, the preset upload information subset based on the association file upload information, to obtain an updated upload information subset; and
determining the updated file data set based on the updated upload information subset and the updated binding data subset.
